(19) United States
(12) Patent Application Publication
(10) Pub. No.: US 2013/0181983 A1
(43) Pub. Date: Jul. 18, 2013

(54) POINT CLOUD DATA PROCESSING DEVICE, POINT CLOUD DATA PROCESSING SYSTEM, POINT CLOUD DATA PROCESSING METHOD, AND POINT CLOUD DATA PROCESSING PROGRAM

(71) Applicant: Kabushiki Kaisha Topcon, Tokyo (JP)

(72) Inventors: Kazuo Kitamura, Tokyo (JP); Nobuo Kochi, Tokyo (JP); Tadayuki Ito, Tokyo (JP); Hitoshi Otani, Tokyo (JP)

(73) Assignee: Kabushiki Kaisha Topcon, Tokyo (JP)

(21) Appl. No.: 13/724,916

(22) Filed: Dec. 21, 2012

Related U.S. Application Data
(63) Continuation of application No. PCT/JP2011/064566, filed on Jun. 24, 2011.

(30) Foreign Application Priority Data
Jun. 25, 2010 (JP) 2010-145211

(51) Int. Cl. G06T 15/00

(52) U.S. Cl. CPC G06T 15/00
USPC 345/419

(57) ABSTRACT

A point cloud data processing device is equipped with a non-plane area removing unit 101, a plane labeling unit 102, and a contour calculating unit 106. The non-plane area removing unit 101 removes point cloud data relating to non-plane areas from point cloud data because the non-plane areas apply a high load in calculation. In the point cloud data, a two-dimensional image of an object is linked with data of three-dimensional coordinates of plural points that form the two-dimensional image. The plane labeling unit 102 adds labels for identifying planes with respect to the point cloud data in which the data of the non-plane areas are removed. The contour calculating unit 106 calculates a contour of the object by using local flat planes based on a local area that is connected with the labeled plane.

### RELATED APPLICATIONS

This application is a continuation of PCT/JP2011/064566 filed on Jun. 24, 2011, which claims priority to Japanese Application No. 2010-145211 filed on Jun. 25, 2010. The entire contents of these applications are incorporated herein by reference.

### FIELD OF THE INVENTION

The present invention relates to point cloud data processing techniques, and specifically relates to a point cloud data processing technique that extracts features of an object from point cloud data thereof and which automatically generates a three-dimensional model in a short time.

### DESCRIPTION OF RELATED ART

As a method for generating a three-dimensional model from point cloud data of an object, a method of connecting adjacent points and forming polygons may be used. In this case, in order to form polygons from several tens of thousands to tens of millions of points of the point cloud data, enormous amounts of processing time are required, and this method is not useful. In view of this, the following techniques are disclosed in, for example, Japanese Unexamined Patent Application Publication (Translation of PCT Application) No. 2000-509150 and Japanese Unexamined Patent Applications Laid-open Nos. 2004-272459 and 2005-024370. In these techniques, only three-dimensional features (edges and planes) are extracted from point cloud data, and three-dimensional polylines are automatically generated.

In the invention disclosed in Japanese Unexamined Patent Application Publication (Translation of PCT Application) No. 2000-509150, a scanning laser device scans a three-dimensional object and generates point clouds. The point cloud is separated into a group of edge points and a group of non-edge points, based on changes in depths and normal lines of the scanned points. Each group is fitted to geometric original drawings, and the fitted geometric original drawings are extended and are crossed, whereby a three-dimensional model is generated.

In the invention disclosed in Japanese Unexamined Patent Application Laid-open No. 2004-272459, segments (triangular polygons) are formed from point cloud data, and edges and planes are extracted based on continuity, directions of normal lines, or distance, of adjacent polygons. Then, the point cloud data of each segment is converted into a flat plane equation or a curved plane equation by the least-squares method and is grouped by planarity and curvature, whereby a three-dimensional model is generated.

In the invention disclosed in Japanese Unexamined Patent Application Laid-open No. 2005-024370, two-dimensional rectangular areas are set for three-dimensional point cloud data, and synthesized normal vectors of measured points in the rectangular areas are obtained. All of the measured points in the rectangular area are rotationally shifted so that the synthesized normal vector corresponds to a z-axis direction. Standard deviation σ of z value of each of the measured points in the rectangular area is calculated. Then, when the standard deviation σ exceeds a predetermined value, the measured point corresponding to the center point in the rectangular area is processed as noise.

### SUMMARY OF THE INVENTION

One of the applications of use of three-dimensional information of an object, which is obtained by a laser device, a stereo imaging device, or the like, is to obtain data for three-dimensional CAD by extracting features of an object. In this case, it is important to obtain necessary data automatically in a short operation time. In view of these circumstances, an object of the present invention is to provide a technique for extracting features of an object from point cloud data thereof and automatically generating data relating to contours of the object in a short time.

According to a first aspect of the present invention, the present invention provides a point cloud data processing device including a non-plane area removing unit, a plane labeling unit, and a contour calculating unit. The non-plane area removing unit removes points of non-plane areas based on point cloud data of an object. The plane labeling unit adds identical labels to points in the same planes other than the points removed by the non-plane area removing unit so as to segment the point cloud data into planes. The contour calculating unit calculates a contour at a portion between a first plane and a second plane, which have the non-plane area therebetween and which have a different label. The contour differentiates the first plane and the second plane. The contour calculating unit includes a local area obtaining unit and a local plane obtaining unit. The local area obtaining unit obtains a local area, which connects with the first plane and is based on the point cloud data of the non-plane area, between the first plane and the second plane. The local plane obtaining unit obtains a local plane that fits to the local area and that differs from the first plane and the second plane in direction. The contour calculating unit calculates the contour based on the local plane.

In the point cloud data, a two-dimensional image is linked with three-dimensional coordinates. That is, in the point cloud data, data of a two-dimensional image of an object, plural target points that are matched with the two-dimensional image, and positions (three-dimensional coordinates) of the target points in a three-dimensional space, are associated with each other. According to the point cloud data, an outer shape of the object is reproduced by using a set of points. Since three-dimensional coordinates of each point are obtained, the relative position of each point is determined. Therefore, a screen-displayed image of an object can be rotated, and the image can be switched to an image that is viewed from a different viewpoint.

In the first aspect of the present invention, the label is an identifier for identifying a plane (or differentiating a plane from other planes). The plane is appropriate to be selected as a target object to be calculated and includes a flat plane, a curved plane with a large curvature, and a curved plane of which a curvature is large and varies slightly according to position. In the present invention, the plane and the non-plane are differentiated according to whether the amount of calculation is acceptable or not when the plane and the non-plane are mathematically processed as data by the calculation. The non-plane includes a corner, an edge portion, a portion with a small curvature, and a portion of which curvature greatly varies according to position. These portions require an enormous amount of calculation when they are mathematically processed as data by the calculation, which applies a high load on a processing device and causes increase of operation time. In the present invention, decreasing of the operation time is one of the objects of the present invention. In view of this, planes which apply a high load on the processing device and which cause increase of the operation time are removed as non-planes so as not to calculate such planes as much as possible.

In the first aspect of the present invention, one plane and another plane, which have a non-plane area therebetween, are used as the first plane and the second plane. In general, when the non-plane area is removed, the two planes that had the non-plane area therebetween are the first plane and the second plane which are adjacent to each other. The present invention is a technique for calculating a contour between the first plane and the second plane.

Contours are lines (outlines) that form an outer shape of an object and that are necessary to visually understand the appearance of the object. Specifically, bent portions, and portions, of which curvatures are suddenly decreased, are the contours. The contours are not only outside frame portions but also edge portions which characterize convexly protruding portions and edge portions which characterize concavely recessed portions (for example, grooved portions). According to the contours, the so-called “line figure” is obtained, and an image that enables easily understanding of the appearance of the object is displayed. Actual contours exist on boundaries between the planes and on the edge portions, but in the present invention, these portions are removed as non-plane areas from the point cloud data. Therefore, the contours are estimated by calculation as described below.

In the first aspect of the present invention, areas that correspond to corners and edge portions of an object are removed as non-plane areas, and the object is electronically processed by a set of planes that are easy to use together as data. According to this function, the appearance of the object is processed as a set of plural planes. Therefore, the amount of data to be dealt with is decreased, whereby the amount of calculation that is necessary to obtain three-dimensional data of the object is decreased. As a result, processing time of the point cloud data is decreased, and processing time for displaying a three-dimensional image of the object and processing times of various calculations based on the three-dimensional image of the object are decreased.

On the other hand, as three-dimensional CAD data, information of three-dimensional contours of an object (data of a line figure) is required in order to visually understand the shape of the object. However, the information of the contours of the object exists between planes and is thereby included in the non-plane area. In view of this, in the first aspect of the present invention, first, the object is processed as a set of planes that require a small amount of calculation, and then contours are estimated by assuming that each contour exists between adjacent planes.

A portion of a contour of the object may include a portion in which curvature changes sharply, such as an edge, or the like. In this regard, it is not efficient to obtain data of the contours by directly calculating obtained point cloud data, because the amount of calculation is increased. In the first aspect of the present invention, point cloud data in the vicinities of contours are removed as non-plane areas, and planes are extracted based on point cloud data of planes that are easy to calculate, first. Then, a local area and a local plane that fits to the local area are obtained. The local area connects with the obtained plane and is based on the point cloud data of the non-plane area, which have been already removed. The local plane fits to the shape of the non-plane area more than in the case of the first plane. The local plane reflects the condition of the non-plane area between the first area and the second area, although it does not completely reflect the condition, whereby the local plane differs from the first plane and the second plane in the direction (normal direction).

Since the local plane reflects the condition of the non-plane area between the first plane and the second plane, a contour is obtained at high approximation accuracy by calculating based on the local plane. In addition, according to this method, the non-plane area is approximated by the local plane, whereby the amount of calculation is decreased. The local plane is effective for decreasing the amount of calculation of a flat plane (local flat plane), but a curved plane may be used as the local plane.

In the first aspect of the present invention, the local area may be adjacent to the first plane or may be at a position distant from the first plane. When the local area is at a position distant from the first plane, the local area and the first plane are connected by one or plural local planes. Continuity of areas is obtained when the following relationship is obtained. That is, the first plane and a local area that is adjacent to the first plane share points, for example, share an edge portion, and the local area and another local area that is adjacent to the local area share other points.

In the first aspect of the present invention, the plane and the non-plane are differentiated based on parameters that are indexes of appropriateness of using a plane as the plane. As the parameters, (1) local curvature, (2) fitting accuracy of a local flat plane, and (3) coplanarity, are described.

The local curvature is a parameter that indicates variation of normal vectors of a target point and surrounding points. For example, when a target point and surrounding points are in the same plane, a normal vector of each point does not vary, whereby the local curvature is smallest.

The local flat plane is obtained by approximating a local area by a flat plane. The fitting accuracy of the local flat plane is an accuracy of correspondence of the calculated local flat plane to the local area that is the base of the local flat plane. The local area is a square area (rectangular area) of approximately 3 to 9 pixels, for example. The local area is approximated by a flat plane (local flat plane) that is easy to process, and an average value of distances between each point in a target local area and a corresponding local flat plane is calculated. The fitting accuracy of the local flat plane to the local area is evaluated by the average value. For example, if the local area is a flat plane, the local area corresponds to the local flat plane, and the fitting accuracy of the local flat plane is highest (best).

The coplanarity is a parameter that indicates a difference of directions of two planes that are adjacent or close to each other. For example, when adjacent flat planes cross each other at 90 degrees, normal vectors of the adjacent flat planes orthogonally cross each other. When an angle between two adjacent flat planes is smaller, an angle between normal vectors of the two adjacent flat planes is smaller. By utilizing this function, whether two adjacent planes are in the same plane or not, and the amount of the positional difference of the two adjacent planes if they are not in the same plane, are evaluated. This amount is the coplanarity. Specifically, when inner products of normal vectors of two local flat planes, which fit to two target local areas, respectively, and a vector connecting center points of the local flat planes, are zero, the local flat planes are determined to be in the same plane. When the inner products are greater, the amount of the positional difference of the two local flat planes is determined to be greater.

A threshold value is set for each of the parameters of (1) local curvature, (2) fitting accuracy of the local flat plane, and (3) coplanarity, and the plane and the non-plane are differentiated according to the threshold values. In general, sharp three-dimensional edges that are generated by change of directions of planes, and non-plane areas that are generated by curved planes with large curvatures, such as smooth three-dimensional edges, are evaluated by the (1) local curvature. Non-plane areas that are generated by occlusion, such as three-dimensional edges, are evaluated mainly by the (2) fitting accuracy of the local flat plane because they have points of which positions suddenly change. The “occlusion” is a condition in which the inner portions are hidden by the front portions and cannot be seen. Non-plane areas that are generated by change of directions of planes, such as sharp three-dimensional edges, are evaluated mainly by the (3) coplanarity.

The evaluation for differentiating the plane and the non-plane may be performed by using one or a plurality of the three kinds of the parameters. For example, when each of the three kinds of the evaluations is performed on a target area, and the target area is identified as a non-plane by at least one of the evaluations, the target area is identified as a non-plane area.

By adjusting the threshold values, a balance of accuracy, calculation time (amount of calculation), and amount of data to be dealt with is controlled. Moreover, the threshold values may also be changed according to an object or application (whether the data is for a precise drawing or for an approximate overhead view, or the like).

According to a second aspect of the present invention, the present invention provides a point cloud data processing device including a non-plane area removing unit, a plane labeling unit, and a contour calculating unit. The non-plane area removing unit removes points of non-plane areas based on point cloud data of an object. The plane labeling unit adds identical labels to points in the same planes other than the points removed by the non-plane area removing unit so as to segment the point cloud data into planes. The contour calculating unit calculates a contour at a portion between a first plane and a second plane, which have the non-plane area therebetween and have a different label. The contour differentiates the first plane and the second plane. The contour calculating unit includes a local area obtaining unit and a local plane obtaining unit. The local area obtaining unit obtains a first local area and a second local area between the first plane and the second plane. The first local area connects with the first plane and is based on the point cloud data of the non-plane area. The second local area connects with the second plane and is based on the point cloud data of the non-plane area. The local plane obtaining unit obtains a first local plane and a second local plane. The first local plane fits to the first local area and differs from the first plane and the second plane in direction. The second local plane fits to the second local area and differs from the first plane and the second plane in direction. The contour calculating unit calculates the contour based on the first local plane and the second local plane.

According to the second aspect of the present invention, a local plane is obtained at each side of the first plane and the second plane. That is, a local plane that extends from the first plane toward the second plane, and a local plane that extends from the second plane toward the first plane, are obtained. Accordingly, accuracy of approximating the non-plane area by the local planes is increased, whereby calculation accuracy of the contour is further increased.

According to a third aspect of the present invention, in the second aspect of the present invention, the first local plane and the second local plane may form a connecting plane that connects the first plane and the second plane. According to the third aspect of the present invention, a portion that was removed as a non-plane area is virtually formed as a connecting plane, and a contour relating to the first plane and the second plane is calculated based on the connecting plane. The connecting plane is a simplified approximated plane that approximates an actual non-plane area. By using the connecting plane, complicated steps of directly calculating a shape of an edge portion based on point cloud data is avoided.

According to a fourth aspect of the present invention, in the second or the third aspect of the present invention, one or plural local planes may be obtained between the first plane and the first local plane and between the second plane and the second local plane.

According to the fourth aspect of the present invention, plural local planes are set from the first plane toward the second plane, and plural local planes are also set from the second plane toward the first plane. Thus, a connecting plane extends from each side of the first plane and the second plane so as to narrow the portion that was removed as the non-plane area. In this case, a leading end portion of the connecting plane that extends from the first plane side is the first local plane, and a leading end portion of the connecting plane that extends from the second plane side is the second local plane. The first local plane and the second local plane extend so as to face each other, and a contour is calculated based on the two adjacent local planes at the leading end portions that face each other. According to this structure, the connecting plane is made so as to finely fit the shape of an actual non-plane area, and a contour is calculated based on the adjacent local planes, whereby the calculation accuracy of the contour is further increased.

According to a fifth aspect of the present invention, in one of the second to the fourth aspects of the present invention, the contour may be calculated as a line of intersection of the first local plane and the second local plane. In the fifth aspect of the present invention, a line of intersection of local planes that are extended from nearest adjacent planes is used as the contour. In this case, one or plural local planes are extended (connected) from the first plane toward the second plane, whereas one or plural local planes are extended (connected) from the second plane toward the first plane. According to this method, even when the shape of the non-plane area is complicated, the connecting plane is formed by connecting smaller local planes, whereby the calculation accuracy of the contour is increased.

According to a sixth aspect of the present invention, in one of the first to the fifth aspects of the present invention, the local area may be a square area that is formed of N×N points in which N is a natural number of not less than three. By setting the local area so as to be formed of a set of points of 3×3, 5×5, 7×7, or the like, and forming the local plane as a local flat plane that fits thereto, speeding-up of the calculation and accuracy of calculated results are balanced. When the number of the points that form the local area is decreased, the accuracy is improved, but the load of the calculation is increased, whereby the processing time is undesirably increased. In contrast, when the number of the points that form the local area is increased, the accuracy is decreased, but the load of the calculation is decreased, whereby the processing time is desirably decreased. In view of this, the upper limit of the number of the points in the local area is desirably approximately 9×9 in order to obtain minimum accuracy.

According to a seventh aspect of the present invention, in one of the first to the sixth aspects of the present invention, a threshold value for evaluating the non-plane area, and a threshold value for evaluating the same planes, may be used. In this case, removing of the points of the non-plane area is performed again by changing the threshold value for evaluating the non-plane area, and adding of the identical labels to the points in the same planes is performed again by changing the threshold value for evaluating the same planes.

According to the seventh aspect of the present invention, the points are reprocessed by changing the threshold values, whereby an area is identified as a plane and is obtained from the area that is once identified as the non-plane area. Therefore, the non-plane area is more narrowed, whereby the calculation accuracy of the contour is increased.

According to an eighth aspect of the present invention, in one of the first to the seventh aspects of the present invention, the point cloud data processing device may further include a smoothing unit for smoothing the contour. The contour is rough due to errors that are generated in a step of obtaining the point cloud data and the step of removing the points of the non-plane area. However, according to the eighth aspect of the present invention, the contour is smoothed.

According to a ninth aspect of the present invention, in one of the first to the eighth aspects of the present invention, the point cloud data processing device may further include a three-dimensional contour image display controlling unit. The three-dimensional contour image display controlling unit controls displaying of a three-dimensional image of the contour of the object on an image display device based on results of the calculation made by the contour calculating unit. According to the ninth aspect of the present invention, an image of the contour of the object based on the point cloud data is displayed on an image display device (for example, a liquid crystal display or the like).

According to a tenth aspect of the present invention, in one of the first to the ninth aspects of the present invention, the point cloud data processing device may further include a display controlling unit, a plane selecting unit, and a selected plane identifying unit. The display controlling unit displays the planes, which are obtained by segmenting the point cloud data by the plane labeling unit, on the image display device. The plane selecting unit enables selection of two adjacent planes from the planes that are displayed on the image display device. The selected plane identifying unit identifies the two adjacent planes as the first plane and the second plane, respectively.

According to the tenth aspect of the present invention, while plural labeled planes are displayed on a screen of the image display device, when a user freely selects adjacent planes from the labeled planes, the adjacent planes are identified. According to this function, the contour is calculated based on the selection of the user. In general, not all of the three-dimensional image information based on point cloud data is necessary for a user. According to the tenth aspect of the present invention, only images of contours of portions that are necessary for a user are displayed. In addition, by calculating only contours of selected portions, processing time for unnecessary calculation is saved.

According to an eleventh aspect of the present invention, in the tenth aspect of the present invention, the planes may be displayed in different display styles. According to the eleventh aspect of the present invention, the labeled different planes are displayed so as to be visually understandable. Therefore, working efficiency of a user for obtaining contours is improved. In this case, the display style may differ by difference in contrasting density, difference in colors, difference in density of displayed dots, difference in hatching treatment, and combinations thereof.

According to a twelfth aspect of the present invention, in the tenth or the eleventh aspect of the present invention, the selected two planes may be highlighted. According to the twelfth aspect of the present invention, the two adjacent planes that are selected by a user are highlighted so as to be visually recognizable. Therefore, working efficiency for selecting planes and displaying contours is improved. As the highlighted display, blinking display, display that is deeper or brighter than those of the other planes, or display with a different color than those of the other planes, may be described. In addition, in order to easily differentiate the two planes that are highlighted, it is also effective to display the two planes in different highlighted conditions.

According a thirteenth aspect of the present invention, in one of the first to the twelfth aspects of the present invention, the point cloud data processing device may further include an unnecessary plane selecting unit and one of a data storage unit and an input receiving unit. The unnecessary plane selecting unit enables selection of a plane, which need not be calculated for obtaining a contour, from the planes that are obtained by segmenting the point cloud data by the plane labeling unit. The data storage unit stores data for selecting the plane that need not be calculated for obtaining a contour. The input receiving unit receives input instruction for selecting the plane that need not be calculated for obtaining a contour.

For example, when a condition in a room is measured, there may be cases in which a contour of furniture that is brought in the room, such as a chair, is not necessary. According to the thirteenth aspect of the present invention, such an unnecessary target object is not selected so as not to calculate a contour thereof, based on data stored in the data storage unit or by a user. Therefore, unnecessary steps by a user and unnecessary calculation in the processing device are decreased.

According to a fourteenth aspect of the present invention, in the thirteenth aspect of the present invention, the point cloud data processing device may further include a hidden contour calculating unit. The hidden contour calculating unit calculates a contour that is hidden behind the plane that need not be calculated for obtaining a contour. According to the fourteenth aspect of the present invention, when a contour relating to, for example, a wall or floor in a room is necessary, a contour of a portion relating to the wall or the floor, which is hidden behind furniture, is calculated. Therefore, a contour of a hidden portion is reproduced without actually removing a desk or the like, which is unnecessary for obtaining the point cloud data.

According to a fifteenth aspect of the present invention, the present invention provides a point cloud data processing device including a rotationally emitting unit, a distance measuring unit, an emitting direction measuring unit, and a three-dimensional coordinate calculating unit. This point cloud data processing device also includes a point cloud data obtaining unit, a non-plane area removing unit, a plane labeling unit, and a contour calculating unit. The rotationally emitting unit rotationally emits distance measuring light on an object. The distance measuring unit measures a distance from the point cloud data processing device to a target point on the object based on flight time of the distance measuring light. The emitting direction measuring unit measures emitting direction of the distance measuring light. The three-dimensional coordinate calculating unit calculates three-dimensional coordinates of the target point based on the distance and the emitting direction. The point cloud data obtaining unit obtains point cloud data of the object based on result of the calculation made by the three-dimensional coordinate calculating unit. The non-plane area removing unit removes points of non-plane areas based on the point cloud data of the object. The plane labeling unit adds identical labels to points in the same planes other than the points removed by the non-plane area removing unit so as to segment the point cloud data into planes. The contour calculating unit calculates a contour at a portion between a first plane and a second plane, which have the non-plane area therebetween and which have a different label. The contour differentiates the first plane and the second plane. The contour calculating unit includes a local area obtaining unit and a local plane obtaining unit. The local area obtaining unit obtains a local area, which connects with the first plane and is based on the point cloud data of the non-plane area, between the first plane and the second plane. The local plane obtaining unit obtains a local plane that fits to the local area and that differs from the first plane and the second plane in direction. The contour calculating unit calculates the contour based on the local plane.

According to a sixteenth aspect of the present invention, the present invention provides a point cloud data processing device including a photographing unit, a feature point matching unit, a photographing position and direction measuring unit, and a three-dimensional coordinate calculating unit. This point cloud data processing device also includes a point cloud data obtaining unit, a non-plane area removing unit, a plane labeling unit, and a contour calculating unit. The photographing unit takes images of an object in overlapped photographing areas from different directions. The feature point matching unit matches feature points in overlapping images obtained by the photographing unit. The photographing position and direction measuring unit measures the position and the direction of the photographing unit. The three-dimensional coordinate calculating unit calculates three-dimensional coordinates of the feature points based on the position and the direction of the photographing unit and the positions of the feature points in the overlapping images. The point cloud data obtaining unit obtains point cloud data of the object based on result of the calculation made by the three-dimensional coordinate calculating unit. The non-plane area removing unit removes points of non-plane areas based on the point cloud data of the object. The plane labeling unit adds identical labels to points in the same planes other than the points removed by the non-plane area removing unit so as to segment the point cloud data into planes. The contour calculating unit calculates a contour at a portion between a first plane and a second plane, which have the non-plane area therebetween and which have a different label. The contour differentiates the first plane and the second plane. The contour calculating unit includes a local area obtaining unit and a local plane obtaining unit. The local area obtaining unit obtains a local area, which connects with the first plane and is based on the point cloud data of the non-plane area, between the first plane and the second plane. The local plane obtaining unit obtains a local plane that fits to the local area and that differs from the first plane and the second plane in direction. The contour calculating unit calculates the contour based on the local plane.

According to a seventeenth aspect of the present invention, the present invention provides a point cloud data processing system including a point cloud data obtaining means, a non-plane area removing means, a plane labeling means, and a contour calculating means. The point cloud data obtaining means optically obtains point cloud data of an object. The non-plane area removing means removes points of non-plane areas based on the point cloud data of the object. The plane labeling means adds identical labels to points in the same planes other than the points removed by the non-plane area removing means so as to segment the point cloud data into planes. The contour calculating means calculates a contour at a portion between a first plane and a second plane, which have the non-plane area therebetween and which have a different label. The contour differentiates the first plane and the second plane. The contour calculating means includes a local area obtaining means and a local plane obtaining means. The local area obtaining means obtains a local area, which connects with the first plane and is based on the point cloud data of the non-plane area, between the first plane and the second plane. The local plane obtaining means obtains a local plane that fits to the local area and that differs from the first plane and the second plane in direction. The contour calculating means calculates the contour based on the local plane.

According to an eighteenth aspect of the present invention, the present invention provides a point cloud data processing method including a non-plane area removing step, a plane labeling step, and a contour calculating step. In the non-plane area removing step, points of non-plane areas are removed based on point cloud data of an object. In the plane labeling step, identical labels are added to points in the same planes other than the points removed by the non-plane area removing means so as to segment the point cloud data into planes. In the contour calculating step, a contour is calculated at a portion between a first plane and a second plane, which have the non-plane area therebetween and which have a different label. The contour differentiates the first plane and the second plane. The contour calculating step includes a local area obtaining step and a local plane obtaining step. In the local area obtaining step, a local area, which connects with the first plane and is based on the point cloud data of the non-plane area, is obtained between the first plane and the second plane. In the local plane obtaining step, a local plane, which fits to the local area and differs from the first plane and the second plane in direction, is obtained. In the contour calculating step, the contour is calculated based on the local plane.

According to a nineteenth aspect of the present invention, the present invention provides a point cloud data processing program to be read and executed by a computer so that the computer functions as the following means. The means include a non-plane area removing means, a plane labeling means, and a contour calculating means. The non-plane area removing means removes points of non-plane areas based on point cloud data of an object. The plane labeling means adds identical labels to points in the same planes other than the points removed by the non-plane area removing means so as to segment the point cloud data into planes. The contour calculating means calculates a contour at a portion between a first plane and a second plane, which have the non-plane area therebetween and which have a different label. The contour differentiates the first plane and the second plane. The contour calculating means includes a local area obtaining means and a local plane obtaining means. The local area obtaining means obtains a local area, which connects with the first plane and is based on the point cloud data of the non-plane area, between the first plane and the second plane. The local plane obtaining means obtains a local plane that fits to the local area and that differs from the first plane and the second plane in direction. The contour calculating means calculates the contour based on the local plane.

The invention according to one of the fifteenth to the nineteenth aspects of the present invention may include the features of one of the second to the fourteenth aspects of the present invention as in the case of the first aspect of the present invention.

According to a twentieth aspect of the present invention, the present invention provides a point cloud data processing device including a non-plane area removing unit, a plane labeling unit, and a contour calculating unit. The non-plane area removing unit removes points of non-plane areas based on point cloud data of an object. The plane labeling unit adds identical labels to points in the same planes other than the points removed by the non-plane area removing unit so as to segment the point cloud data into planes. The contour calculating unit calculates a contour at a portion between a first plane and a second plane, which have the non-plane area therebetween and which have a different label. The contour differentiates the first plane and the second plane. The contour calculating unit includes a local area obtaining unit and a local line obtaining unit. The local area obtaining unit obtains a local area, which connects with the first plane and is based on the point cloud data of the non-plane area, between the first plane and the second plane. The local line obtaining unit obtains a local line that fits to the local area and that is not parallel to the first plane and the second plane. The contour calculating unit calculates the contour based on the local line.

In the twentieth aspect of the present invention, a local line that fits to a local area is a local one-dimensional space and is obtained instead of a local flat plane, which is a local two-dimensional space and is obtained in the first aspect of the present invention. The local line fits to a target local area, and it extends along a direction from the first plane toward the second plane and has a limited length. This method can be understood as the following method. That is, in the first aspect of the present invention, a local line that fits to a target local area is calculated by decreasing a width of a local plane, and a contour is obtained by using the local line instead of the local plane. The local line may be a straight line or a curved line.

According to the twentieth aspect of the present invention, an intersection point of the local lines is a contour passing point. In this case, by connecting plural calculated intersection points, a contour is obtained. The intersection points to be connected need not be adjacent to each other. For example, if a contour is a straight line or is approximate to a straight line, two separated points are obtained by the invention according to the twentieth aspect of the present invention and are connected, whereby a contour is obtained. In this case, the amount of calculation is greatly decreased.

The invention according to the twentieth aspect of the present invention may be used as an invention of a method, an invention of a system, or an invention of a program, as in the case of the invention according to the first aspect of the present invention. Moreover, the invention according to the twentieth aspect of the present invention may also be used as a method of extending a local line from each of two planes as in the case of the invention according to the second aspect of the present invention. The invention according to the twentieth aspect of the present invention may include the features in one of the second to the fourteenth aspect of the present invention.

### EFFECTS OF THE INVENTION

According to the present invention, a technique for extracting features of an object from point cloud data thereof and automatically generating data relating to contours of the object in a short time is provided.

### BRIEF DESCRIPTION OF THE DRAWINGS

FIG. 1 is a block diagram of a point cloud data processing device of an embodiment.

FIG. 2 is a flow chart showing a processing flow of an embodiment.

FIG. 3 is a conceptual diagram showing an example of an object.

FIG. 4 is a conceptual diagram showing a condition of edges of labeled planes.

FIG. 5 is a conceptual diagram showing a function for calculating a contour.

FIGS. 6A and 6B are conceptual diagrams showing a function for calculating a contour.

FIGS. 7A and 7B are block diagrams showing examples of a contour calculating unit.

FIG. 8 is a conceptual diagram showing a relationship between edges of labeled planes and a contour.

FIGS. 9A to 9C are conceptual diagrams showing a model in which contours are obtained.

FIG. 10 is a conceptual diagram showing a function for calculating a contour.

FIGS. 11A and 11B are conceptual diagrams showing a function for calculating a contour.

FIG. 12 is a conceptual diagram of a point cloud data processing device including a function of a three-dimensional laser scanner.

FIG. 13 is a conceptual diagram of a point cloud data processing device including a function of a three-dimensional laser scanner.

FIG. 14 is a block diagram of a control system of an embodiment.

FIG. 15 is a block diagram of a processing unit of an embodiment.

FIG. 16 is a conceptual diagram showing an example of steps of forming a grid.

FIG. 17 is a conceptual diagram showing an example of a grid.

FIG. 18 is a conceptual diagram of a point cloud data processing device including a function of obtaining three-dimensional information by stereo cameras.

FIG. 19 is a block diagram of an embodiment.

### DETAILED DESCRIPTION OF THE PREFERRED EMBODIMENTS

### 1. First Embodiment

An example of a point cloud data processing device will be described with reference to the figures hereinafter. The point cloud data processing device in this embodiment is equipped with a non-plane area removing unit, a plane labeling unit, and a contour calculating unit. The non-plane area removing unit removes point cloud data relating to non-plane areas from point cloud data because the non-plane areas apply a high load in calculation. In the point cloud data, a two-dimensional image of an object is linked with data of three-dimensional coordinates of plural points that corresponds to the two-dimensional image. The plane labeling unit adds labels to the point cloud data in which the data of the non-plane areas are removed, so as to identify planes. The contour calculating unit calculates a contour of the object by using a local flat plane that is based on a local area connected with the labeled plane.

### Structure of Point Cloud Data Processing Device

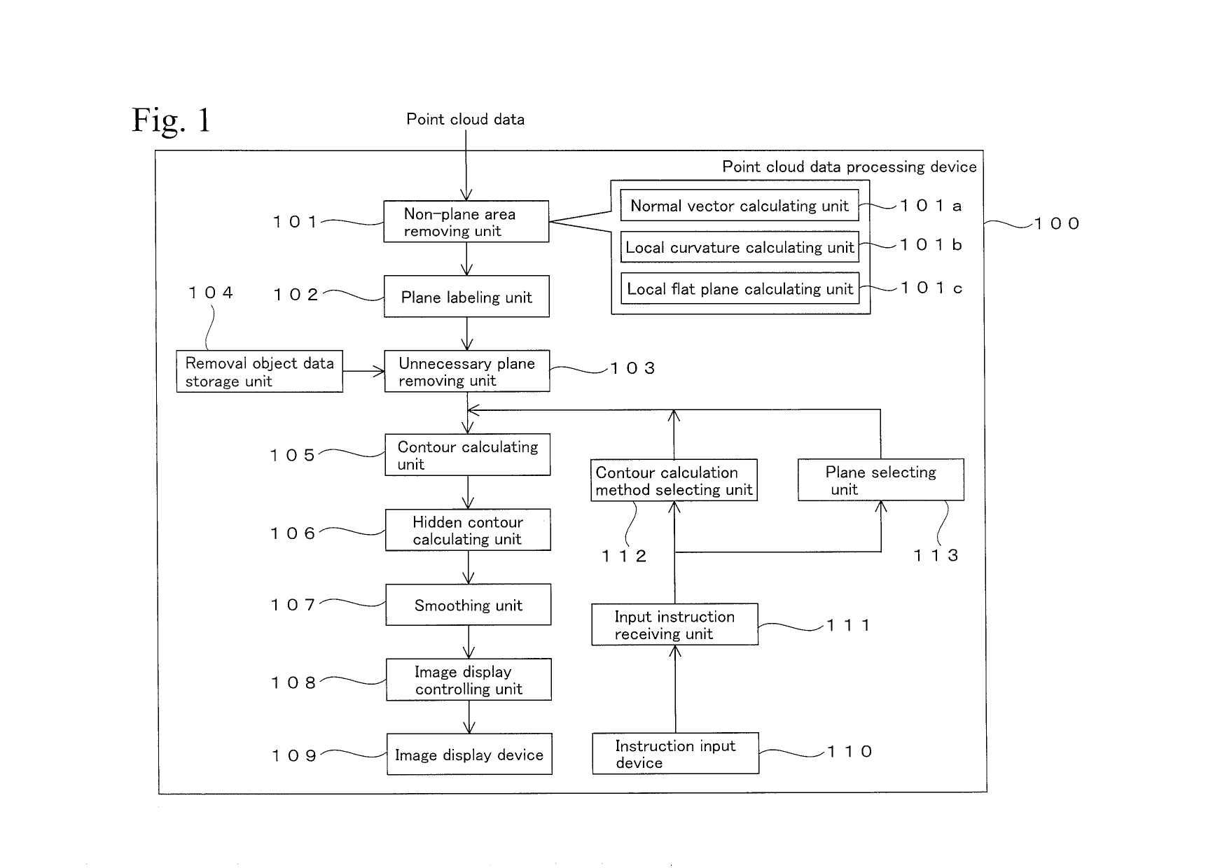

FIG. 1 is a block diagram of a point cloud data processing device. A point cloud data processing device 100 extracts features of an object based on point cloud data thereof and generates a three-dimensional model based on the features. The point cloud data is obtained by a three-dimensional position measuring device (three-dimensional laser scanner) or a stereoscopic image information obtaining device. The three-dimensional position measuring device obtains data of three-dimensional coordinates of the object as the point cloud data by emitting laser light and scanning. The stereoscopic image information obtaining device obtains stereoscopic image information by using plural imaging devices and obtains data of three-dimensional coordinates of the object as the point cloud data, based on the stereoscopic image information. These devices may have structures that will be described later.

The point cloud data processing device 100 shown in FIG. 1 is programmed in a notebook size personal computer. That is, the personal computer, in which dedicated software for processing point clouds using the present invention is installed, functions as the point cloud data processing device in FIG. 1. This program does not have to be installed in the personal computer, and it may be stored in a server or an appropriate recording medium and may be provided therefrom.

The personal computer to be used is equipped with an input unit, a display such as a liquid crystal display, a GUI (Graphical User Interface) function unit, a CPU and the other dedicated processing units, a semiconductor memory, a hard disk, a disk drive, an interface unit, and a communication interface unit, as necessary. The input unit may be a keyboard, a touchscreen, or the like. The GUI function unit is a user interface for combining the input unit and the display unit. The disk drive transfers information with a storage media such as an optical disk or the like. The interface unit transfers information with a portable storage media such as a USB memory or the like. The communication interface unit performs wireless communication or wired communication. The personal computer is not limited to the notebook size type and may be in another form such as a portable type, a desktop type, or the like. Instead of using a general-purpose personal computer, the point cloud data processing device 100 may be formed of dedicated hardware using an ASIC (Application Specific Integrated Circuit), a PLD (Programmable Logic Device) such as a FPGA (Field Programmable Gate Array), or the like.

### (A) Structure Relating to Calculation of Contour

First, a structure for processing calculation of a contour in the point cloud data processing device 100 will be described. The point cloud data processing device 100 is equipped with a non-plane area removing unit 101, a plane labeling unit 102, an unnecessary plane removing unit 103, a removal object data storage unit 104, and a contour calculating unit 105. Each of these function units will be described hereinafter.

### A1: Non-Plane Area Removing Unit

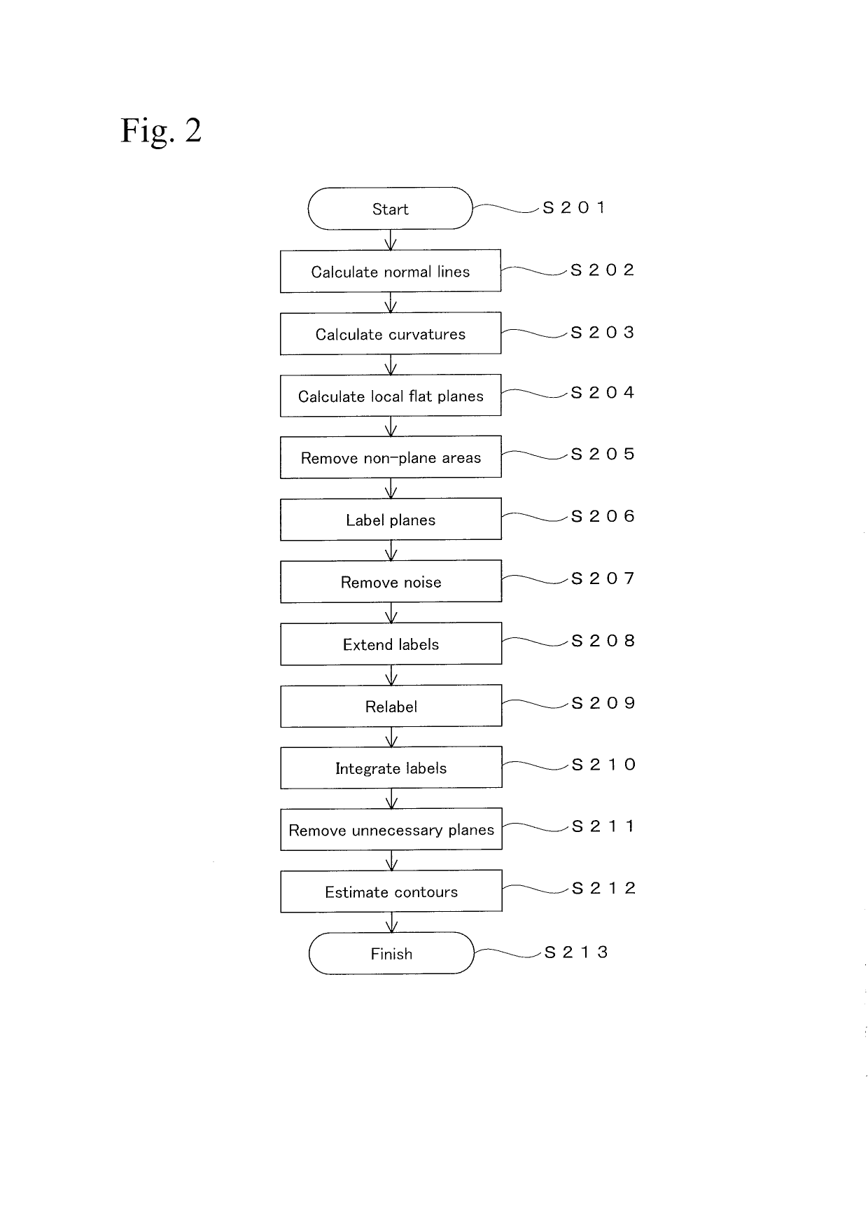

FIG. 2 is a flow chart showing an example of processing that is performed in the point cloud data processing device 100. FIG. 2 shows steps S202 to S204 that are processed by the non-plane area removing unit 101. The non-plane area removing unit 101 includes a normal vector calculating unit 101a, a local flat plane calculating unit 101c, and a local curvature calculating unit 101b. The normal vector calculating unit 101a calculates a normal vector of a local area, which will be described later. The local flat plane calculating unit 101c calculates a local flat plane that fits to the local area. The local curvature calculating unit 101b calculates a local curvature of the local area. These function units will be described hereinafter according to the flow of processing.

An appearance of an object is represented by data of plural points, and a point cloud data is a set of data of three-dimensional coordinates of each of the points. The normal vector calculating unit 101a calculates a normal vector of each of the points based on the point cloud data (step S202). In the calculation of the normal vector, a square area (grid-like area) of approximately 3 to 7 pixels on a side, which has a target point at the center, is used as a local area, and point cloud data of the local area is used. The normal vector calculating unit 101a calculates a normal vector of each point within the local area. This calculation is performed on the entirety of the point cloud data. That is, the point cloud data is segmented into numerous local areas, and a normal vector of each point in each of the local areas is calculated.

The local curvature calculating unit 101b calculates a variation (local curvature) of the normal vectors in the local area (step S203). In this case, in a target local area, an average (mNVx, mNVy, mNVz) of intensity values (NVx, NVy, NVz) of the three axis components of each normal vector is calculated. In addition, a standard deviation (StdNVx, StdNVy, StdNVz) is calculated. Then, a square-root of a sum of squares of the standard deviation is calculated as a local curvature (crv) (see the following First Formula).

Local Curvature=(StdNVx²+StdNVy²+StdNVz²)^{1/2} First Formula

The local flat plane calculating unit 101c calculates a local flat plane in the local area (step S204). In this calculation, an equation of a local flat plane is obtained from three-dimensional coordinates of each point in a target local area (local flat plane fitting). The local flat plane is made so as to fit to the target local area. In this case, the equation of the local flat plane that fits to the target local area is obtained by the least-squares method. Specifically, plural equations of different flat planes are obtained and are compared, whereby the equation of the local flat plane that fits to the target local area is obtained. If the target local area is a flat plane, a local flat plane coincides with the local area.

The calculation is repeated so as to be performed on the entirety of the point cloud data by sequentially forming a local area, whereby normal vectors, a local flat plane, and a local curvature, of each of the local areas are obtained.

Next, points of non-plane areas are removed based on the normal vectors, the local flat plane, and the local curvature, of each of the local areas (step S205). That is, in order to extract planes (flat planes and curved planes), portions (non-plane areas), which can be preliminarily identified as non-planes, are removed. The non-plane areas are areas other than the flat planes and the curved planes, but there may be cases in which curved planes with high curvatures are included according to threshold values of the following methods (1) to (3).

The removal of the non-plane areas is performed by at least one of the following three methods. In this embodiment, evaluations according to the following methods (1) to (3) are performed on all of the local areas. If the local area is identified as a non-plane area by at least one of the three methods, the local area is extracted as a local area that forms a non-plane area. Then, point cloud data relating to points that form the extracted non-plane area are removed.

(1) Portion with High Local Curvature

The local curvature that is calculated in the step S203 is compared with a predetermined threshold value, and a local area having a local curvature that exceeds the threshold value is identified as a non-plane area. The local curvature indicates variation of normal vectors of the target point and surrounding points. Therefore, the local curvature is small with respect to planes (flat planes and curved planes with small curvatures), whereas the local curvature is large with respect to areas other than the planes (non-planes). Accordingly, when the local curvature is greater than the predetermined threshold value, the target local area is identified as a non-plane area.

### (2) Fitting Accuracy of Local Flat Plane

Distances between each point in a target local area and a corresponding local flat plane are calculated. When an average of these distances is greater than a predetermined threshold value, the target local area is identified as a non-plane area. That is, when a target local area differs from the shape of a flat plane, and the difference is greater, the distances between each point in the target local area and the corresponding local flat plane are greater. By using this function, degree of non-planarity of a target local area is evaluated.

### (3) Check of Coplanarity

The directions of local flat planes that correspond to adjacent local areas are compared. When the difference in the directions of the local flat planes exceeds a threshold value, the adjacent local areas are identified as non-plane areas. Specifically, two local flat planes that fit to two target local areas, respectively, have a normal vector and a connecting vector that connects center points in the local flat planes. When inner products of each of the normal vectors and the connecting vector are zero, both of the local flat planes are determined to exist in the same plane. When the inner products are greater, the two local flat planes are more separated and are not in the same plane.

A local area that is identified as a non-plane area by at least one of the three methods (1) to (3) is extracted as a local area which forms a non-plane area. Then, point cloud data relating to points that form the extracted local area are removed from point cloud data to be calculated. As described above, non-plane areas are removed in the step S205 in FIG. 2. Thus, point cloud data of non-plane areas are removed from the point cloud data input in the point cloud data processing device 100 by the non-plane area removing unit 101. Since the removed point cloud data may be used in later steps, these point cloud data may be stored in an appropriate storage area or may be set so as to be identified from the remaining point cloud data, in order to make them available later.

### A2: Plane Labeling Unit

Next, function of the plane labeling unit 102 will be described with reference to FIG. 2. The plane labeling unit 102 executes processing of step S206 and the subsequent steps in FIG. 2 with respect to the point cloud data that are processed by the non-plane area removing unit 101.

The plane labeling unit 102 performs plane labeling on the point cloud data, in which the point cloud data of the non-plane areas are removed by the non-plane area removing unit 101, based on continuity of normal vectors (step S206). Specifically, when an angle difference of normal vectors of a target point and an adjacent point is not more than a predetermined threshold value, identical labels are added to these points. By repeating this processing, identical labels are added to each of connected flat planes and connected curved planes with small curvatures, whereby each of the connected flat planes and the connected curved planes are made identifiable as one plane. After the plane labeling is performed in the step S206, whether the label (plane) is a flat plane or a curved plane with a small curvature is evaluated by using the angular difference of the normal vectors and standard deviations of the three axial components of the normal vectors. Then, identifying data for identifying the result of this evaluation are linked to each of the labels.

Labels (planes) with small areas are removed as noise (step S207). The removal of noise may be performed at the same time as the plane labeling of the step S206. In this case, while the plane labeling is performed, the number of the identical labels (number of points forming the identical label) is counted, and labels that have points at not more than a predetermined number are cancelled. Then, a label of the nearest plane is added to the points with no label at this time. Accordingly, the labeled planes are extended (step S208).

The detail of the processing in the step S207 will be described as follows. First, an equation of a labeled plane is obtained, and a distance between the labeled plane and a point with no label is calculated. When there are plural labels (planes) around the point with no label, a label having a smallest distance from the point is selected. If points with no label still exist, each of the threshold values in the removal of non-plane areas (step S205), the removal of noise (step S207), and the extension of label (step S208), is changed, and related processing (relabeling) is performed again (step S209). For example, by increasing the threshold value of the local curvature in the removal of non-plane areas (step S205), fewer points are extracted as non-planes. In another case, by increasing the threshold value of the distance between the point with no label and the nearest plane in the extension of label (step S208), labels are added to more of the points with no label.

When planes have different labels but are in the same planes, the labels of the planes are integrated (step S210). That is, identical labels are added to planes that have the same position or the same direction, even if the planes are not continuous planes. Specifically, by comparing the positions and the directions of the normal vectors of each plane, discontinuous same planes are extracted, and the labels thereof are integrated into one of the labels thereof. These are the function of the plane labeling unit 102.

According to the function of the plane labeling unit 102, the amount of data to be dealt with is compacted, whereby the point cloud data is processed at higher speed. In addition, the amount of necessary memory is decreased. Moreover, point cloud data of passersby and passing vehicles during taking of point cloud data of an object are removed as noise.

An example of a displayed image based on the point cloud data that are processed by the plane labeling unit 102 will be described as follows. FIG. 3 shows a cube 120 as an example of an object. In this case, the cube 120 is obliquely downwardly scanned with a laser scanner, and point cloud data of the cube 120 is obtained. When this point cloud data is processed in the steps S201 to S210 in FIG. 2, three planes shown in FIG. 3 are labeled, and image data is obtained. The image data is apparently similar to the image shown in FIG. 3 when viewed from a distance.

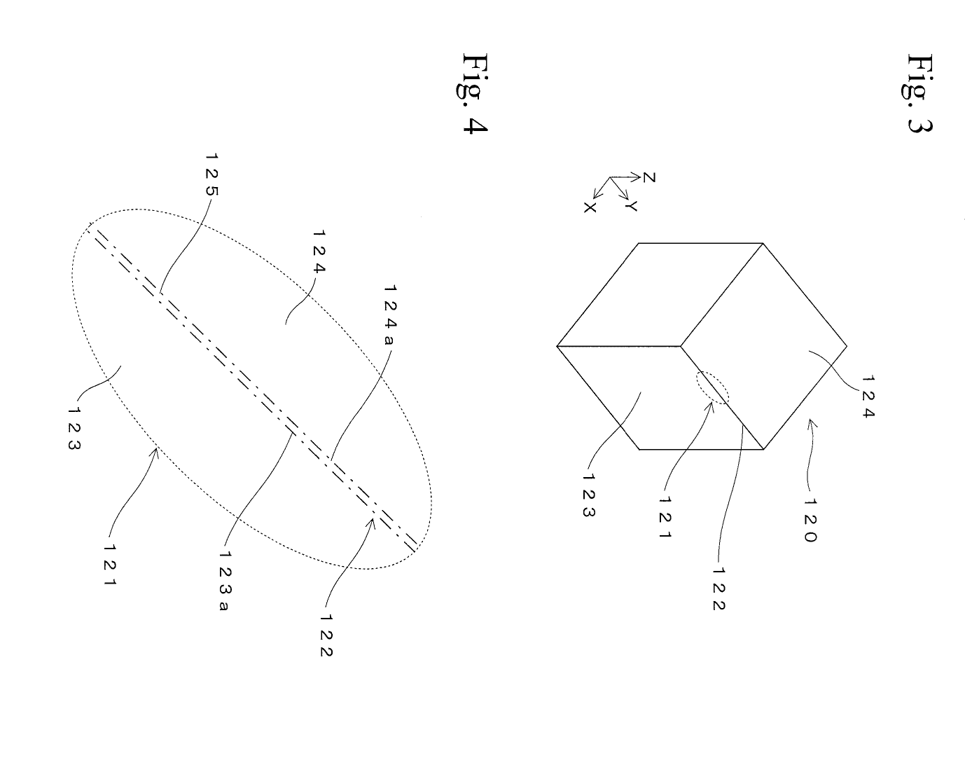

However, when the vicinity of a boundary between a flat plane 123 and a flat plane 124 is enlarged, an outer edge 123a on the flat plane 124 side of the flat plane 123 and an outer edge 124a on the flat plane 123 side of the flat plane 124 do not coincide with each other and extend approximately parallel as shown in FIG. 4. That is, a contour 122 of the cube 120 is not correctly reproduced.

This is because data of the portion of the contour 122 is for an edge portion at a boundary portion between the flat planes 123 and 124 that form the cube 120, and this data is removed from the point cloud data as a non-plane area 125. Since the flat planes 123 and 124 are labeled and have a different label, point cloud data of the outer edge 123a of an outside edge of the flat plane 123 and the outer edge 124a of an outside edge of the flat plane 124 are processed. Therefore, the outer edges 123a and 124a are displayed. On the other hand, there is no point cloud data of the portion (non-plane area 125) between the outer edges 123a and 124a, whereby image information relating to the non-plane area 125 is not displayed.

For this reason, when the image is displayed based on the output of the plane labeling unit 102, the contour 122 of the boundary between the flat planes 123 and 124 is not correctly displayed. In this embodiment, in order to make the point cloud data processing device 100 output point cloud data of, for example, the contour 122 in the above example, a contour calculating unit 105 is arranged. The contour calculating unit 105 will be described later.

### A3: Unnecessary Plane Removing Unit

The unnecessary plane removing unit 103 removes data of planes relating to objects, of which data of contours are not necessary, from the point cloud data (step S211). These objects may be automobiles that are parked in front of buildings, furniture (chairs and the like) in rooms, and the like. This processing is performed based on data that are stored in the removal object data storage unit.

The removal object data storage unit 104 stores a list relating to objects of which data of contours are not necessary, such as automobiles and furniture, as described above. A preliminarily prepared list is used for this list. The unnecessary plane removing unit 103 extracts objects, which are identified as unnecessary objects, from an image data that is output from the plane labeling unit 102 based on publicly known image identifying processing. Then, planes (labeled planes) relating to the extracted objects are removed.

According to the function of the unnecessary plane removing unit 103, data of the planes (data of the labeled planes) of the objects of which contours need not be calculated are removed. Therefore, unnecessary calculation is avoided in calculation of the contours. The processing of the unnecessary plane removing unit 103 may be bypassed, and in this case, this function of the unnecessary plane removing unit 103 is not obtained.

In addition, unnecessary objects may be selected by a user. In this case, unnecessary objects or unnecessary planes are selected by a user with publicly known GUI function, whereby point cloud data relating to the selected objects or the selected planes are removed by the unnecessary plane removing unit 103.

### A4: Contour Calculating Unit

The contour calculating unit 105 calculates (estimates) a contour based on point cloud data of adjacent planes (step S212 in FIG. 2). A specific calculation method will be described hereinafter.

### First Calculation Method

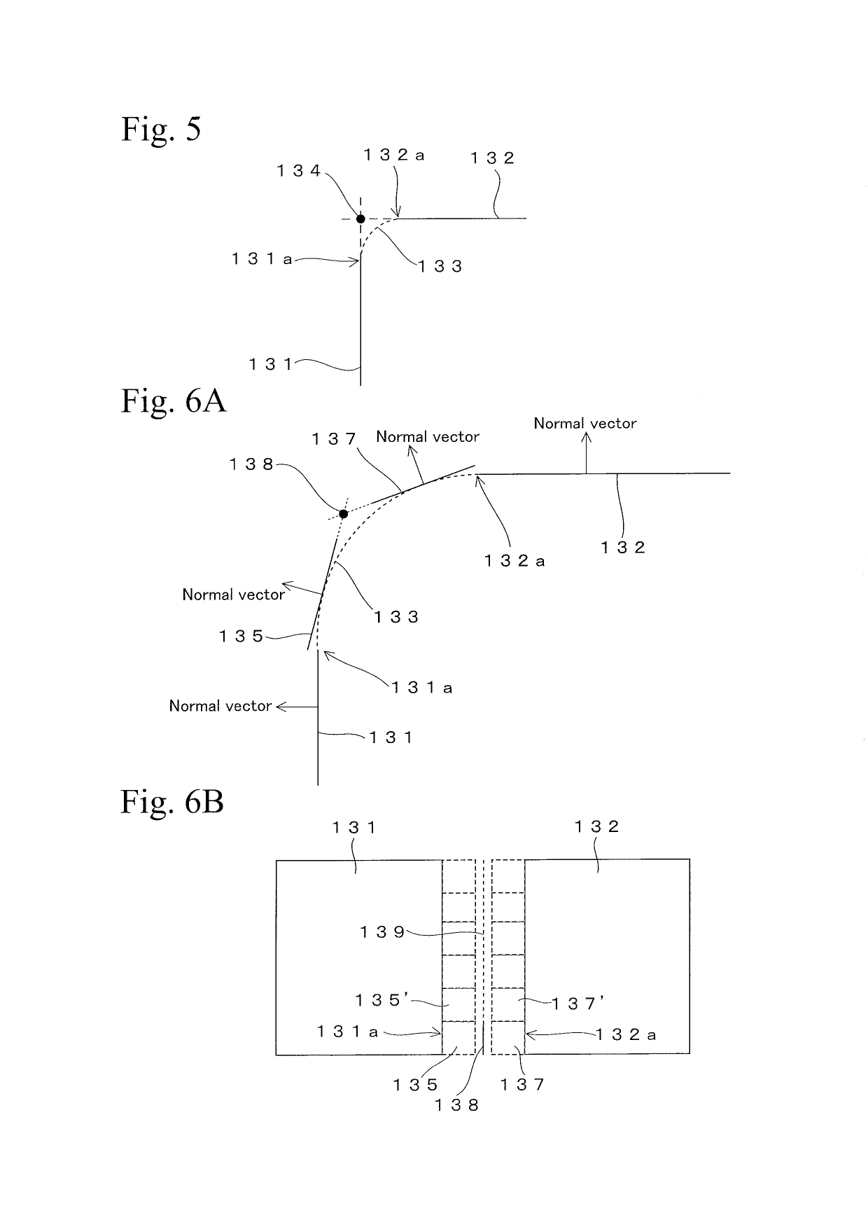

FIG. 5 shows one of functions of a method for calculating a contour. FIG. 5 conceptually shows the vicinity of a boundary between a flat plane 131 and a flat plane 132. In this case, a non-plane area 133 with a small curvature is removed in the removal of non-plane areas, and the adjacent flat planes 131 and 132 are labeled as planes. The flat plane 131 has an outer edge 131a on the flat plane side 132, and the flat plane 132 has an outer edge 132a on the flat plane 131 side. Since point cloud data of a portion between the outer edges 131a and 132a is removed as a non-plane area, data of a contour that exists in the non-plane area 133 are not directly obtained from the point cloud data.

In this regard, in this example, the following processing is performed by the contour calculating unit 105. First, the flat planes 132 and 131 are extended, and a line 134 of intersection thereof is calculated. The line 134 of the intersection is used as a contour that is estimated. The portion which extends from the flat plane 131 to the line 134 of the intersection, and the portion which extends from the flat plane 132 to the line 134 of the intersection, form a polyhedron. The polyhedron is an approximate connecting plane that connects the flat planes 131 and 132. When the flat planes 131 and 132 are curved planes, flat planes having normal vectors of portions at the outer edges 131a and 132a are assumed and are extended, whereby the line 134 of the intersection is calculated.

This method enables easy calculation compared with other methods and is appropriate for high-speed processing. On the other hand, a distance between an actual non-plane area and a calculated contour tends to be large, and there is a high probability of generating a large margin of error. Nevertheless, when an edge is sharp or a non-plane area has a small width, the margin of error is small, whereby the advantage of short processing time is utilized.

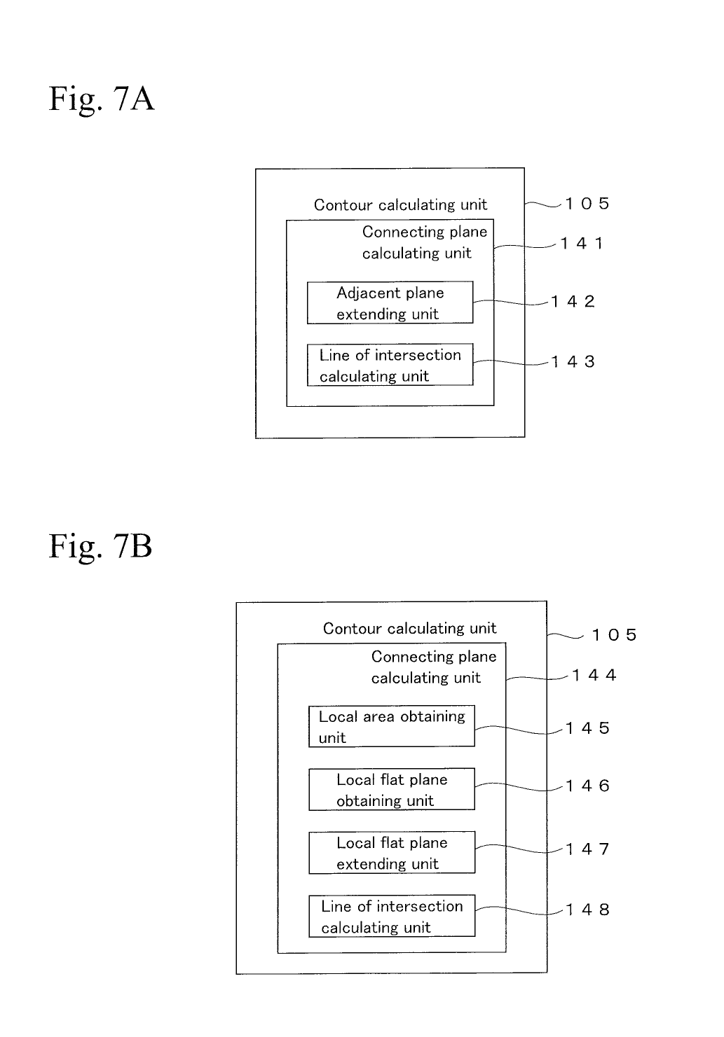

A structure of the contour calculating unit 105 in FIG. 1 for performing the first calculation method is shown in FIG. 7A. In this case, the contour calculating unit 105 includes a connecting plane calculating unit 141 that has an adjacent plane extending unit 142 and a line of intersection calculating unit 143. The adjacent plane extending unit 142 extends a first plane and a second plane that are adjacent to each other. The line of intersection calculating unit 143 calculates a line of intersection of the first plane and the second plane that are extended.

### Second Calculation Method

FIGS. 6A and 6B shows a function of a method for calculating a contour. FIG. 6A shows a conceptual diagram viewed from a direction of a cross section that is obtained by perpendicularly cutting the planes shown in FIG. 5. FIG. 6B shows a conceptual diagram (model figure) of an overview of the two planes and a contour therebetween. FIGS. 6A and 6B conceptually show the vicinity of a boundary between the flat planes 131 and 132 as in the case shown in FIG. 5. In this case, the non-plane area 133 with the small curvature is removed in the removal of non-plane areas, and the adjacent flat planes 131 and 132 are labeled as planes as in the case shown in FIG. 5.

An example of processing will be described hereinafter. First, a local area, which includes a point of the outer edge 131a on the flat plane 132 side of the flat plane 131 and is located on the flat plane 132 side, is obtained. The local area shares the outer edge 131a of the flat plane 131 at an edge portion thereof and is a local square area that forms a part of the non-plane area 133, such as an area of 3×3 points or 5×5 points. The local area shares the outer edge 131a of the flat plane 131 at the edge portion thereof and is thereby connected with the flat plane 131. Then, a local flat plane 135 that fits to this local area is obtained. The local flat plane 135 is affected primarily by the shape of the non-plane area 133, and a direction of a normal vector thereof (direction of the plane) differs from directions of normal vectors of the flat planes 131 and 132 (directions of the planes). The local flat plane is calculated by the same method as in the local flat plane calculating unit 101c.

Next, a local area, which includes a point of the outer edge 132a on the flat plane 131 side of the flat plane 132 and is located on the flat plane 131 side, is obtained. Then, a local flat plane 137 that fits to this local area is obtained. When there is a space for setting more local flat planes between the local flat planes 135 and 137 (or it is necessary to set more local flat planes in order to increase accuracy), the same processing is repeated. Thus, local flat planes are fitted to the local area in the non-plane area 133 from the flat plane 131 side toward the flat plane 132 side and from the flat plane 132 side toward the flat plane 131 side. That is, the non-plane area 133 is approximated by connecting the local flat planes.

In this example, the distance between the local flat planes 135 and 137 is not more than a threshold value and is identified as a space in which more local flat planes need not be set. Therefore, a line of intersection of the local flat planes 135 and 137, which are close and adjacent to each other, is obtained, and a contour 138 is calculated. The local flat plane 135, the local flat plane 137, and each portion that extends from the local flat plane 135 or 137 to the line of the intersection, form a polyhedron. The polyhedron is an approximate connecting plane that connects the flat planes 131 and 132. According to this method, the connecting plane that connects the flat planes 131 and 132 is formed by connecting the local flat planes that fit to the non-plane area. Therefore, the calculation accuracy of the contour is more increased compared with the case shown in FIG. 5.

Thus, as shown in FIG. 6B, the contour 138 (line element of contour) having a similar length to the local flat planes 135 and 137 is obtained. By performing this processing along the extending direction of the non-plane area, a contour 139 that segments the flat planes 131 and 132 is calculated. Specifically, after the contour 138 shown in FIG. 6A is calculated, local flat planes 135′ and 137′ are obtained by the same method, and a portion of a contour therebetween is calculated. By repeating this processing, the short contour 138 is extended, and the contour 139 is obtained.

An example of further setting local flat planes on the flat plane 132 side of the local flat plane 135 will be described hereinafter. First, a local area, which includes a point of an edge on the flat plane 132 side of the local area that is a base of the local flat plane 135, is obtained. This local area is located on the flat plane 132 side. In addition, a local flat plane that fits to the local area is obtained. This processing is also performed on the flat plane 132 side. This processing is repeated on each of the flat plane sides, and the local flat planes are connected, whereby a connecting plane is formed. When a space between two local flat planes, which face and are close to each other, becomes not more than the threshold value, a line of intersection of the two local flat planes is calculated and is obtained as a contour.

The plural local areas that are sequentially obtained from the first plane toward the second plane share some points with the adjacent first plane or adjacent local areas. Therefore, each of the plural local areas is connected with the first plane. That is, a local area that is separated from the first plane is used as a local area that is connected with the first plane as long as the local area is obtained according to the above-described processing. Although each of adjacent local flat planes fits to the connected local area, the adjacent local flat planes differ from each other in direction depending on the shape of the non-plane area. Accordingly, there may be cases in which the local flat planes are not completely connected, and a polyhedron including openings may be formed in a precise sense. However, the openings are ignored and used as connecting planes for the structure of the polyhedron.

A structure of the contour calculating unit 105 in FIG. 1 for performing the second calculation method is shown in FIG. 7B. In this case, the contour calculating unit 105 includes a connecting plane calculating unit 144. The connecting plane calculating unit 144 includes a local area obtaining unit 145, a local flat plane obtaining unit 146, a local flat plane extending unit 147, and a line of intersection calculating unit 148. The local area obtaining unit 145 obtains local areas that are necessary for obtaining the local flat planes 135 and 137. The local flat plane obtaining unit 146 obtains local flat planes that fit to the local areas obtained by the local area obtaining unit 145. The local flat plane extending unit 147 extends a local flat plane (local flat plane 135 in the case shown in FIGS. 6A and 6B), which is extended from the flat plane 131 toward the flat plane 132. In addition, the local flat plane extending unit 147 extends a local flat plane (local flat plane 137 in the case shown in FIGS. 6A and 6B), which is extended from the flat plane 132 toward the flat plane 131. The line of intersection calculating unit 148 calculates a line of intersection of the local flat planes that are extended.

According to this method, a space (portion of the non-plane area) between the first plane and the second plane, which are adjacent to each other via the non-plane area, is connected with the local flat planes. After the space is gradually narrowed until the space is sufficiently small, a line of intersection of the local flat planes, which are adjacent to each other via the space, is calculated and is obtained as a contour. As a standard for evaluating whether more local flat planes are required between the local flat planes 135 and 137, a difference in the direction of the normal vectors of the local flat planes 135 and 137 may be used. In this case, if the difference in the direction of the normal vectors of the local flat planes 135 and 137 is not more than a threshold value, it is determined that the contour is to be calculated at high accuracy by using the line of intersection of the local flat planes 135 and 137. Therefore, more local flat planes are not obtained, and a contour is calculated based on the line of the intersection of the local flat planes 135 and 137 as in the case shown in FIGS. 6A and 6B.

### Third Calculation Method

In this method, the removal of non-plane areas and the plane labeling are performed again by changing the threshold value with respect to the area that is identified as a non-plane area in the initial processing. As a result, a more limited non-plane area is removed, and a contour is then calculated by using one of the first calculation method and the second calculation method again.

The non-plane area to be removed may be further narrowed by changing the threshold value two or three times and recalculating, in order to increase the accuracy. In this case, if the repeated number of the calculation is increased by changing the threshold value, the calculation time is increased. Therefore, it is desirable to set an appropriate threshold value for the number of change of the threshold value so that the processing is advanced to the calculation of the contour by the other calculation method when the recalculation is performed some times.

### Fourth Calculation Method

A method of using a local straight line instead of the local flat plane may be used in a similar manner as in the case of the second calculation method. In this case, the local flat plane calculating unit 101c in FIG. 1 functions as a local straight line calculating unit. This method will be described with reference to FIGS. 6A and 6B hereinafter. In the conceptual diagram in FIGS. 6A and 6B, the portions indicated by the reference numerals 135 and 137 are used as local straight lines. The local straight line is obtained by narrowing the local flat plane so as to have a width of one point (there is no width in mathematical terms). This method is performed in the same manner as in the case of the local flat plane. First, a local area that connects with the flat plane 131 is obtained, and a local straight line, which fits to this local area and extends toward the flat plane 132, is calculated. Then, a connecting line (in this case, not a plane but a line) that connects the flat planes 131 and 132 is formed by the local straight line.

The local straight line is calculated as in the case of the local flat plane, and it is obtained by calculating an equation of a line, which fits to a target local area, using the least-squares method. Specifically, plural equations of different straight lines are obtained and compared, and an equation of a straight line that fits to the target local area is obtained. If the target local area is a flat plane, a local straight line and the local area are parallel. Since the local area, to which a local straight line is fitted, is a local area that forms a part of the non-plane area 133, the local straight line (in this case, the reference numeral 135) is not parallel to the flat planes 131 and 132.

The same processing is also performed on the plane 132 side, and a local straight line that is indicated by the reference numeral 137 is calculated. Then, an intersection point of the two local straight lines (in this case, the reference numeral 138) is obtained as a contour passing point. The actual contour is calculated by obtaining plural intersection points and connecting them. The contour may be calculated by obtaining intersection points of local straight lines at adjacent portions and by connecting them. On the other hand, the contour may be calculated by obtaining plural intersection points of local straight lines at portions at plural point intervals and by connecting them.

Moreover, the contour may be calculated by setting plural local straight lines at smaller local areas so as to form a connecting line made of shorter local straight lines. This method is the same as in the case of the calculation of the contour using the local flat planes, which is described in the second calculation method.

### Another Calculation Method

As another method for estimating a contour by calculating a line of intersection of local flat planes, a method of setting a contour at a center portion of a connecting plane may be described. In this case, one of the following methods may be used for calculating a center portion of a connecting plane. That is, (1) a method of using a center portion of a connecting plane may be used by assuming that a contour passes therethrough, whereby a contour is calculated. On the other hand, (2) a method of using a center point of a plane, which has a normal line at (or close to) the middle of a variation range of normal lines of local planes (change of direction of planes), as a contour passing point, may be used. Alternatively, (3) a method of using a portion, which has a largest rate of change of normal lines of local planes (change of direction of planes), as a contour passing point, may be used. As the local plane, a local curved plane may be used. In this case, a curved plane that is easy to use as data is selected and is used instead of the local flat plane. On the other hand, a method of preparing plural kinds of local planes and selecting a local plane that fits closely to the local area therefrom, may be used.

### Example of Contour

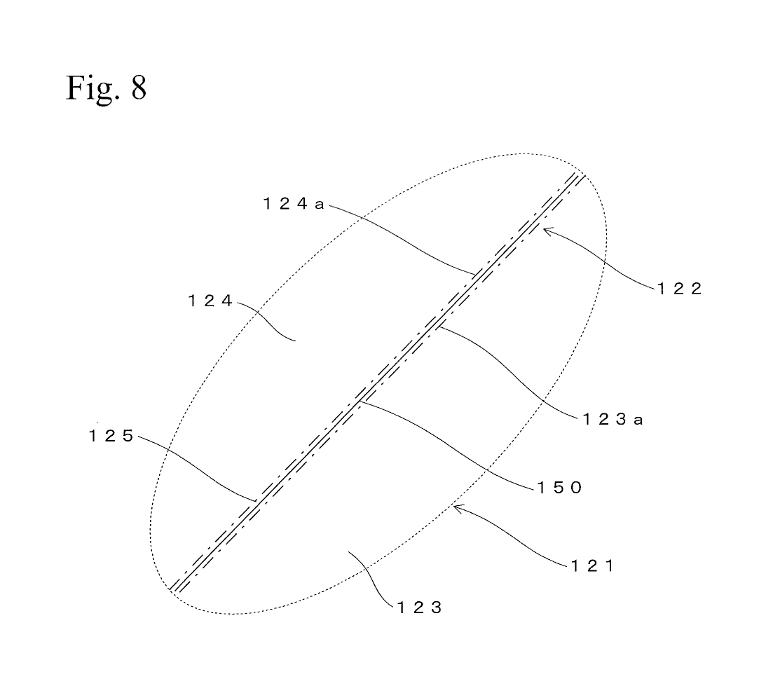

An example of a calculated contour will be described as follows. FIG. 8 is a conceptual diagram corresponding to FIG. 4. FIG. 8 shows a case in which a contour 150 is calculated by the calculation of contour (the second calculation method) as described in this embodiment in the condition shown in FIG. 4. In this case, in the area which is removed as the non-plane area, a connecting plane that connects the labeled flat planes 123 and 124 is calculated based on the outer edge 123a of the flat plane 123 and the outer edge 124a of the flat plane 124 by the second calculation method (see FIGS. 6A and 6B). Then, a line of intersection of two local flat planes that form the connecting plane is obtained, whereby the contour 150 is calculated. By calculating the contour 150, the indistinct image of the outline of the object (in this case, the cube 120) in FIG. 3 is clarified. Accordingly, by taking the data of the contour in three-dimensional CAD data, an image data suitable to be used as CAD data is obtained from the point cloud data.

### (B) Structure for Other Processing Relating to Contour

Structures other than the non-plane area removing unit 101, the plane labeling unit 102, the unnecessary plane removing unit 103, and the contour calculating unit 105 in the point cloud data processing device 100 will be described hereinafter.

### B1: Hidden Contour Calculating Unit

The point cloud data processing device 100 is also equipped with a hidden contour calculating unit 106. Whereas the data of the planes of which contours need not be calculated are removed by the unnecessary plane removing unit 103, a contour may be hidden behind the removed planes. The hidden contour calculating unit 106 calculates the hidden contour based on the data of the contours that are calculated by the contour calculating unit 105.

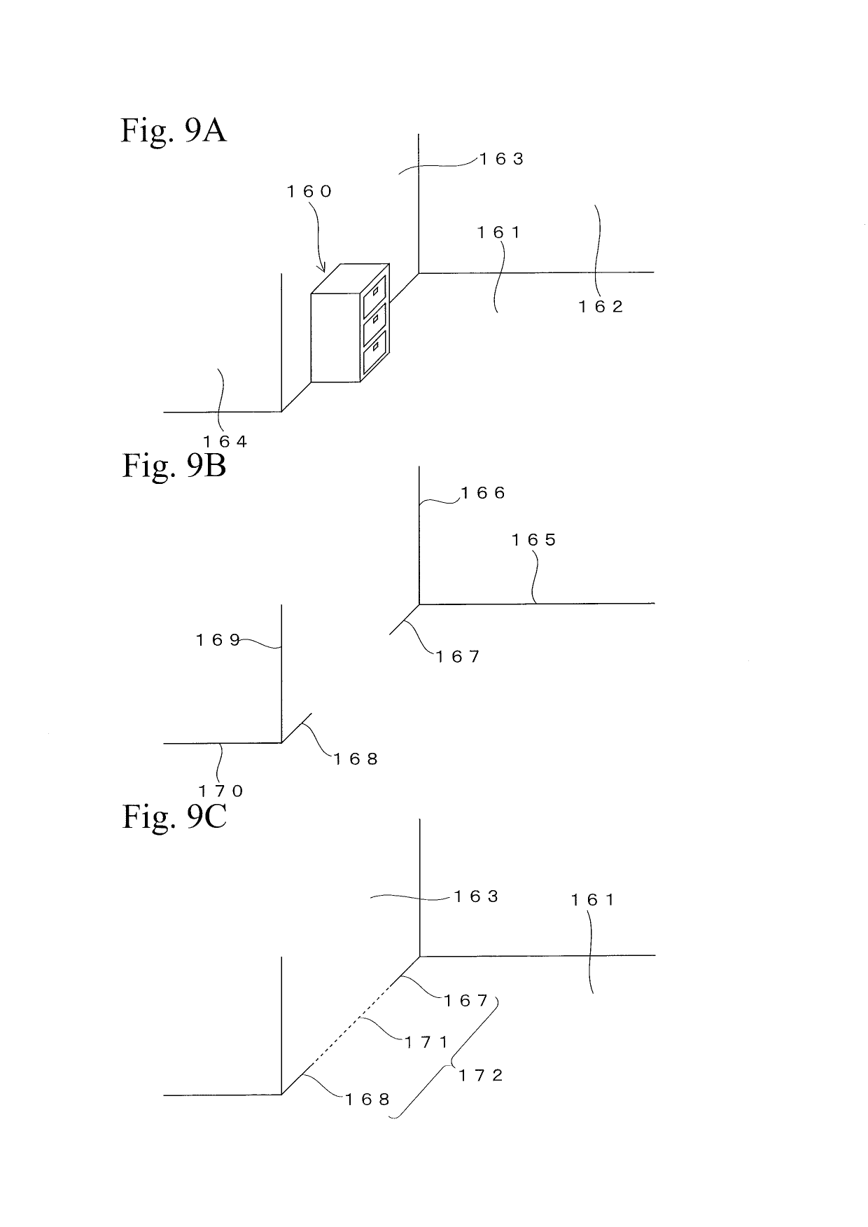

A specific example will be described hereinafter. FIGS. 9A to 9C conceptually show a case in which the interior of a room is used as an object to be measured. FIG. 9A shows the condition inside the room, which is viewed by eye. In this case, point cloud data are obtained with respect to the interior of the room as an object and are then processed by the point cloud data processing device 100 in FIG. 1. According to the function of the plane labeling unit 102, planes relating to a floor surface 161, wall surfaces 162, 163, and 164, and an outer surface of a drawer 160 of furniture arranged in the room, are labeled.

Data for selecting the drawer as a removal object may be stored in the removal object data storage unit 104. In this case, the unnecessary plane removing unit 103 processes data that are output from the plane labeling unit 102, whereby data of the planes relating to the drawer 160 are removed. This condition is shown in FIG. 9B. FIG. 9B shows a condition in which a contour 165, a contour 166, contours 167 and 168, and a contour 170, are displayed. The contour 165 separates the floor surface 161 and the wall surface 162. The contour 166 separates the wall surfaces 162 and 163. The contours 167 and 168 separate the floor surface 161 and the wall surface 163. The contour 170 separates the floor surface 161 and the wall surface 164.

Since there are no point cloud data for the portion hidden by the drawer 160, this portion is represented by a space by the data. Therefore, as shown in FIG. 9B, a contour that separates the floor surface 161 and the wall surface 163 is partially disconnected at the portion hidden by the drawer 160, and it is separated into the contours 167 and 168.

The hidden contour calculating unit 106 calculates for complementing the disconnected portion with a contour. Specifically, an equation for the contour 167 is obtained, and a portion that extends from the contour 167 to the contour 168 is calculated based on this equation. FIG. 9C shows the calculated portion as a contour 171. In an actual display screen, the contour 171 is represented in the same condition as the other contours and cannot be identified from the other contour portions (for example, the portion indicated by the reference numeral 167). It is also possible to display the portion that is indicated by the reference numeral 171 so as to be identified from others. Thus, a contour 172 that separates the floor surface 161 and the wall surface 163 is displayed without a disconnected portion.

### B2: Smoothing Unit

The point cloud data processing device 100 in FIG. 1 is also equipped with a smoothing unit 107. The smoothing unit 107 corrects a calculated contour so as to be a smooth line when the contour is displayed. While an image of a plane that is labeled by the plane labeling unit 102 is displayed, a contour for an edge of the plane may be represented by a broken line of short bent portions when it is enlarged. This is because the edge of the plane is also an edge of a non-plane area, whereby errors occur during obtaining of point cloud data and selecting of the obtained point cloud data.

In a case of taking the data of the contour in CAD data, the portion that must be a straight line is undesirably displayed by a broken line when enlarged. In addition, the volume of the data of the broken line is greater than that of the data of the straight line, which is not preferable in view of reducing a memory region and calculation speed.

The smoothing unit 107 evaluates the degree of the broken line from distances between the bent portions and replaces the bent portions with straight lines when the distances are not more than a predetermined threshold value. For example, in the case of measuring the condition inside the room in FIG. 9A, the contours are rarely repeatedly bent at intervals of a few centimeters. Therefore, in this case, the threshold value may be set at 5 cm, and bent portions are replaced with straight lines if the distances between the bent portions are not more than the threshold value and the number of the bendings is not less than three times. When there is a portion that should be replaced according to the evaluation, an equation of a straight line is obtained for the portion by assuming that bent portions of a contour are a straight line. Then, the contour is smoothed (in this case, straightened) based on this equation.

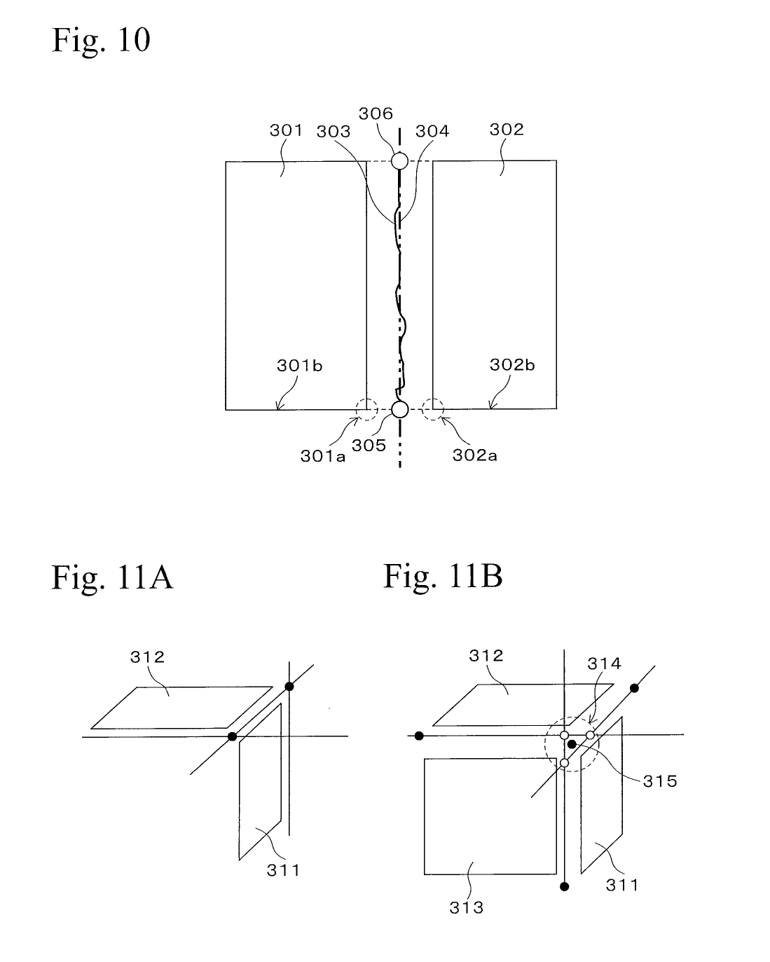

Another example of the calculation method for the straight contour will be described hereinafter. It is assumed that two flat planes are adjacent to each other via a non-plane area. FIG. 10 shows flat planes 301 and 302, which have a non-plane area therebetween. FIG. 10 shows a contour 303 before it is smoothed for reference. The contour 303 is calculated by the processing that is described relating to FIGS. 6A, 6B, and 8. The contour 303 is a broken line (exaggeratedly shown in FIG. 10) due to errors in sampling of point cloud data and in calculations. The reference numeral 304 indicates a contour that is straightened by the smoothing as described above.

In the following method, the calculation method using the local planes, of which function is shown in FIGS. 6A and 6B, is not used with respect to the entirety of a contour. Alternatively, two points 305 and 306 are calculated at both ends of the flat planes 301 and 302 (on a line connecting edges on the upper side in FIG. 10 and on a line connecting edges on the lower side in FIG. 10). Then, the points 305 and 306 are connected with a straight line, whereby a contour is calculated.

First, the points 305 and 306 are obtained by the fourth calculation method. A method for obtaining the point 305 will be described as follows. The flat plane 301 has a portion indicated by reference numeral 301a and an edge 301b on the lower side in FIG. 10. The flat plane 302 has a portion indicated by reference numeral 302a and has an edge 302b on the lower side in FIG. 10. In this case, one or plural local straight lines, which are described relating to FIGS. 6A and 6B, are set from the portions of the reference numerals 301a and 302a, and an intersection point is finally calculated. Accordingly, a contour passing point corresponding to the portion of the reference numeral 138 in FIGS. 6A and 6B is calculated. That is, the edge 301b of the flat plane 301 is extended toward the flat plane 302, whereas the edge 302b of the flat plane 302 is extended toward the flat plane 301, by the method of setting local straight lines. Then, an intersection point of closest portions is obtained as the point of the reference numeral 305. The position of the point 306 is also calculated by the same manner.

By obtaining a straight line that connects the points 305 and 306, the contour 304 is calculated. In this method, only two points and a straight line that connects the two points have to be calculated, and a straight contour is directly obtained, whereby the amount of calculation is decreased. In this case, since it is only necessary to obtain the contour passing point, the method of setting local straight lines in the fourth calculation method is used because it enables simpler calculation. However, the points 305 and 306 may be calculated by the method of setting local flat planes in the second calculation method.

Next, an example of a calculation method for a contour in a case of three or more flat planes will be described hereinafter. In this case, the flat planes are adjacent to each other at different angles (at different directions). This method may be used for calculating a contour relating to a corner portion of a floor or a ceiling, and a corner portion of a cube, for example.

FIG. 11A shows two flat planes 311 and 312 that are adjacent to each other via a non-plane area and that have a different direction. FIG. 11B conceptually shows a combination of three different flat planes 311, 312, and 313, which is based on the structure shown in FIG. 11A. According to the method described relating to FIG. 10, two intersection points between the adjacent flat planes 311 and 312, two intersection points between the adjacent flat planes 311 and 313, and two intersection points between the adjacent flat planes 312 and 313, are obtained. The flat planes 311, 312, and 313 abut on each other at a corner, and three intersection points in the vicinity 314 of the corner are used as provisional intersection points. Then, three-dimensional coordinates of the three provisional intersection points are obtained, and average values thereof are calculated, whereby a position of coordinates of the average values is set as an intersection point 315 of the three flat planes 311, 312, and 313. Thus, an intersection point of plural planes is calculated.

For example, in a case of calculating contours that connect four corners of a ceiling portion of a room, an intersection point of two wall surfaces and a ceiling surface is calculated at four portions by using the above-described method. Then, by connecting the intersection points of the four potions, straight contours that separate the ceiling and the wall surfaces are obtained.

The smoothing of a contour is also applied to a case in which a contour to be smoothed is a curved line. In this case, a portion of which bent portions need to be smoothed is selected from the contour of the curved line according to the same function as in the above-described case. Then, an equation of a curved line for replacing the portion with a smooth curved line is obtained, and the contour is smoothed based on this equation of the curved line.

### B3: Unit and Device Relating to Image Display

The point cloud data processing device 100 in FIG. 1 is also equipped with an image display controlling unit 108 and an image display device 109. The image display device 109 may be a liquid crystal display of a notebook size personal computer that functions as the point cloud data processing device. The image display controlling unit 108 controls displaying of image information, which is obtained by the processing with the point cloud data processing device 100, on the image display device 109.

The image to be displayed on the image display device 109 includes an image of an object represented by planes that are obtained by the processing in the plane labeling unit 102 and an image in which unnecessary objects are removed by the unnecessary plane removing unit 103. The image to be displayed on the image display device 109 also includes an image of contours that are calculated by the contour calculating unit 105, an image of contours that are calculated by the hidden contour calculating unit 106, and an image of contours that are smoothed by the smoothing unit 107. Moreover, the image to be displayed on the image display device 109 includes an image simultaneously including a plurality of the above-described images, an image for explanation relating to operation of the point cloud data processing device 100, an image for setting the threshold values and the like, and an image for operation of the GUI that is controlled by a user.

The image display controlling unit 108 controls the images by providing colors so that a plane, which is labeled by the plane labeling unit, is differentiated from adjacent planes and is easily perceived. Specifically, a first plane may be displayed in red, whereas an adjacent second plane may be displayed in blue. Thus, the image display controlling unit 108 controls the displayed planes by providing colors so that the different labeled planes are clearly easily perceived by eye. In this processing, since it is only necessary to make the different labeled planes be easily perceived by eye, difference in contrasting density, difference in density of displayed dots, difference in hatching treatment, and combinations thereof, may be used. The image display controlling unit 108 highlights two planes when the two planes are selected by a user in order to calculate a contour therebetween. As a method for highlighting, a method of displaying the two planes with greatly different colors from the other planes, and a method of blinking the two planes, may be used.

### B4: Unit and Device Relating to Operation

The point cloud data processing device 100 is also equipped with an instruction input device 110 and an input instruction receiving unit 111. The instruction input device 110 is formed of a keyboard device or a mouse-type device of the notebook size personal computer, and a GUI function unit. By controlling the instruction input device 110, the point cloud data processing device 100 is operated. The input instruction receiving unit 111 receives instructions that are input by a user with the instruction input device 110 and converts the instructions into data so as to be processable in the point cloud data processing device 100.

### B5: Units Relating to Manual Control

The point cloud data processing device 100 is provided with a function for selecting a method for calculating a contour and a function for selecting a portion to be calculated for a contour. In order to perform these functions, the point cloud data processing device 100 is further equipped with a contour calculation method selecting unit 112 and a plane selecting unit 113.

The contour calculation method selecting unit 112 is a function unit and enables a user to select a method from the plural methods for calculating a contour as described above. For example, symbols for the kinds of the calculation methods may be displayed at an end of the image display device. In this case, when a user selects one of the methods by using the GUI function of the personal computer, the contour calculation method selecting unit 112 recognizes the selected calculation method. Then, the contour calculating unit 105 calculates a contour by the selected calculation method. According to this function, whether the priority is the accuracy or the processing speed is selected by a user.

The plane selecting unit 113 is used for selecting the position to be calculated for a contour by a user. For example, in the example shown in FIG. 9A, when a user controls the instruction input device 110 in FIG. 1 and selects the wall surfaces 162 and 163, the instruction is recognized by the input instruction receiving unit 111 and is then recognized by the plane selecting unit 113. After the plane selecting unit 113 recognizes the instruction of the user, it sends data for identifying the selected wall surfaces 162 and 163 to the contour calculating unit 105. In response to this, the contour calculating unit 105 calculates the contour 166 that separates the wall surfaces 162 and 163. At this time, according to the function of the image display controlling unit 108, the selected two planes are highlighted and are displayed so as to be easily perceived by the user.

### 2. Second Embodiment

A point cloud data processing device equipped with a three-dimensional laser scanner will be described hereinafter. In this example, the point cloud data processing device emits distance measuring light (laser light) and scans with respect to an object and measures a distance to each target point on the object therefrom based on flight time of the laser light. Then, the point cloud data processing device measures the emitted direction (horizontal angle and elevation angle) of the laser light and calculates three-dimensional coordinates of the target point based on the distance and the emitted direction. The point cloud data processing device takes two-dimensional images (RGB intensity of each of the target points) that are photographs of the object and forms point cloud data by linking the two-dimensional images and the three-dimensional coordinates. Next, the point cloud data processing device generates a line figure, which is formed of contours and shows three-dimensional outlines of the object, from the point cloud data.

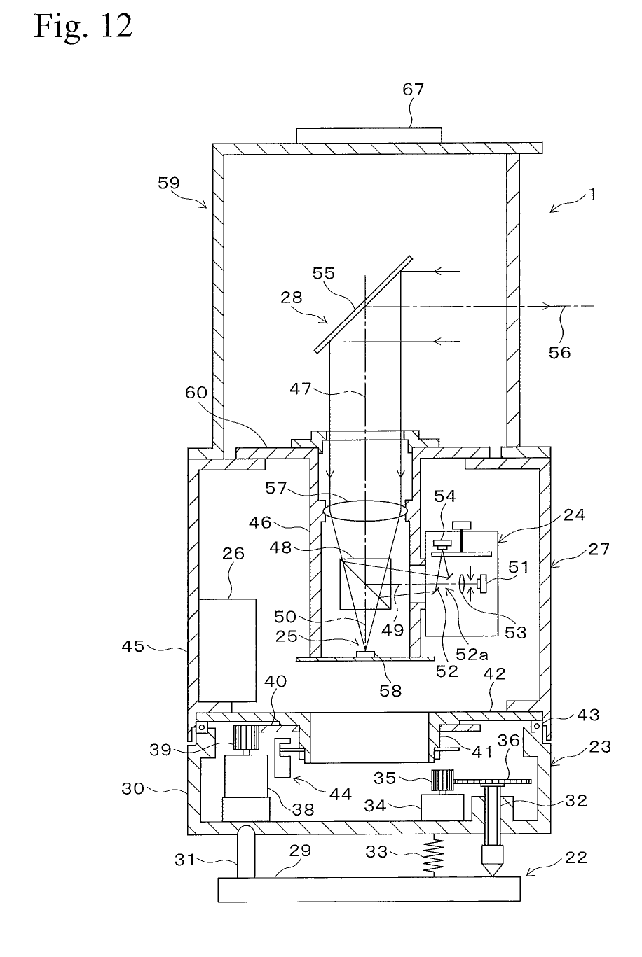

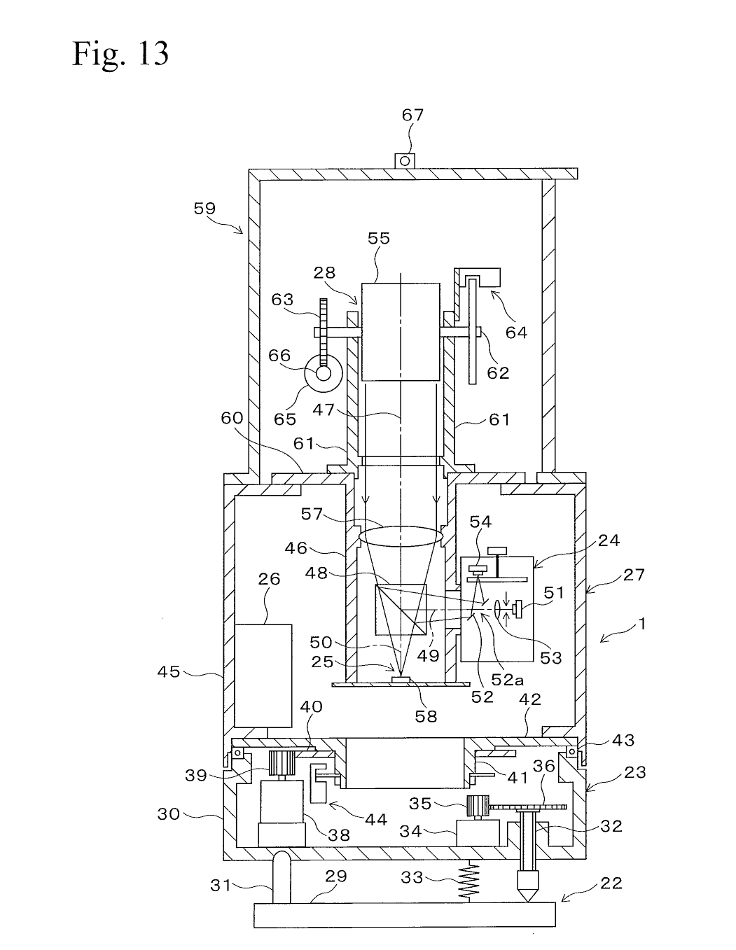

FIGS. 12 and 13 are cross sections showing a structure of a point cloud data processing device 1. The point cloud data processing device 1 is equipped with a level unit 22, a rotational mechanism 23, a main body 27, and a rotationally emitting unit 28. The main body 27 is formed of a distance measuring unit 24, an imaging unit 25, and a controlling unit 26, etc. For convenience of description, FIG. 13 shows the point cloud data processing device 1 in which only the rotationally emitting unit 28 is viewed from a side direction with respect to the cross-section direction shown in FIG. 12.

The level unit 22 has a base plate 29, and the rotational mechanism 23 has a lower casing 30. The lower casing 30 is supported by the base plate 29 with three points of a pin 31 and two adjusting screws 32. The lower casing 30 is tiltable on a fulcrum of a head of the pin 31. An extension spring 33 is provided between the base plate 29 and the lower casing 30 so that they are not separated from each other.

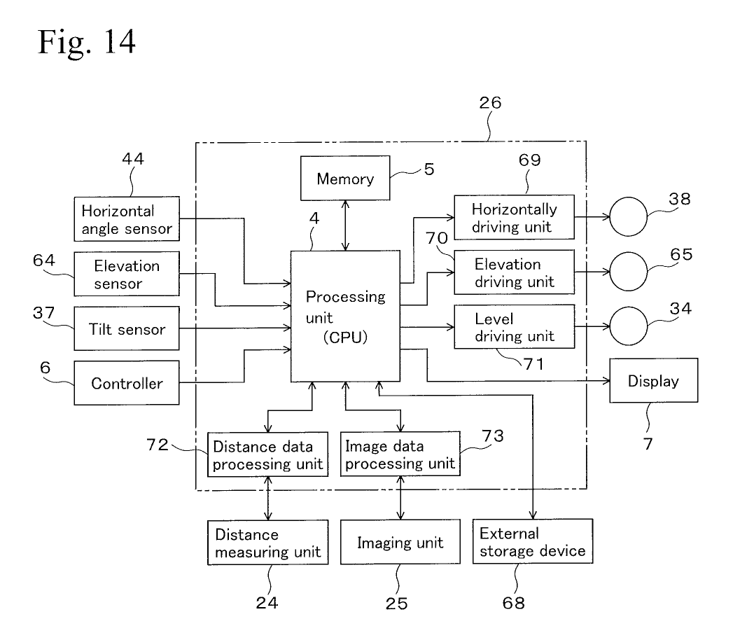

Two level motors 34 are provided inside the lower casing 30. The two level motors 34 are driven independently of each other by the controlling unit 26. By driving the level motors 34, the adjusting screws 32 rotate via a level driving gear 35 and a level driven gear 36, and the downwardly protruded amounts of the adjusting screws 32 are adjusted. Moreover, a tilt sensor 37 (see FIG. 14) is provided inside the lower casing 30. The two level motors 34 are driven by detection signals of the tilt sensor 37, whereby leveling is performed.

The rotational mechanism 23 has a horizontal rotation driving motor 38 inside the lower casing 30. The horizontal rotation driving motor 38 has an output shaft into which a horizontal rotation driving gear 39 is fitted. The horizontal rotation driving gear 39 is engaged with a horizontal rotation gear 40. The horizontal rotation gear 40 is provided to a rotating shaft portion 41. The rotating shaft portion 41 is provided at the center portion of a rotating base 42. The rotating base 42 is provided on the lower casing 30 via a bearing 43.

The rotating shaft portion 41 is provided with, for example, an encoder, as a horizontal angle sensor 44. The horizontal angle sensor 44 measures a relative rotational angle (horizontal angle) of the rotating shaft portion 41 with respect to the lower casing 30. The horizontal angle is input to the controlling unit 26, and the controlling unit 26 controls the horizontal rotation driving motor 38 based on the measured results.

The main body 27 has a main body casing 45. The main body casing 45 is securely fixed to the rotating base 42. A lens tube 46 is provided inside the main body casing 45. The lens tube 46 has a rotation center that is concentric with the rotation center of the main body casing 45. The rotation center of the lens tube 46 corresponds to an optical axis 47. A beam splitter 48 as a means for splitting light flux is provided inside the lens tube 46. The beam splitter 48 transmits visible light and reflects infrared light. The optical axis 47 is split into an optical axis 49 and an optical axis 50 by the beam splitter 48.

The distance measuring unit 24 is provided to the outer peripheral portion of the lens tube 46. The distance measuring unit 24 has a pulse laser light source 51 as a light emitting portion. The pulse laser light source 51 and the beam splitter 48 are provided with a perforated mirror 52 and a beam waist changing optical system 53 therebetween. The beam waist changing optical system 53 changes beam waist diameter of the laser light. The pulse laser light source 51, the beam waist changing optical system 53, and the perforated mirror 52, form a distance measuring light source unit. The perforated mirror 52 introduces the pulse laser light from a hole 52a to the beam splitter 48 and reflects laser light, which is reflected at the object and returns, to a distance measuring-light receiver 54.

The pulse laser light source 51 is controlled by the controlling unit 26 and emits infrared pulse laser light at a predetermined timing accordingly. The infrared pulse laser light is reflected to an elevation adjusting rotating mirror 55 by the beam splitter 48. The elevation adjusting rotating mirror 55 reflects the infrared pulse laser light to the object. The elevation adjusting rotating mirror 55 turns in the elevation direction and thereby converts the optical axis 47 extending in the vertical direction into a floodlight axis 56 in the elevation direction. A focusing lens 57 is arranged between the beam splitter 48 and the elevation adjusting rotating mirror 55 and inside the lens tube 46.

The laser light reflected at the object is guided to the distance measuring-light receiver 54 via the elevation adjusting rotating mirror 55, the focusing lens 57, the beam splitter 48, and the perforated mirror 52. In addition, reference light is also guided to the distance measuring-light receiver 54 through an inner reference light path. Based on a difference between two times, a distance from the point cloud data processing device 1 to the object (target point) is measured. One of the two times is a time until the laser light is reflected and is received at the distance measuring-light receiver 5, and the other is a time until the laser light is received at the distance measuring-light receiver 54 through the inner reference light path.

The imaging unit 25 has an image sensor 58 that is provided at the bottom of the lens tube 46. The image sensor 58 is formed of a device in which a great number of pixels are flatly assembled and arrayed, for example, a CCD (Charge Coupled Device). The position of each pixel of the image sensor 58 is identified by the optical axis 50. For example, the optical axis 50 may be used as the origin, and an X-Y coordinate is assumed, whereby the pixel is defined as a point on the X-Y coordinate.

The rotationally emitting unit 28 is contained in a floodlight casing 59 in which a part of the circumferential wall is made as a floodlight window. As shown in FIG. 13, the lens tube 46 has a flange portion 60 to which two mirror holding plates 61 are oppositely provided. A rotating shaft 62 is laid between the mirror holding plates 61. The elevation adjusting rotating mirror 55 is fixed to the rotating shaft 62. The rotating shaft 62 has an end into which an elevation gear 63 is fitted. An elevation sensor 64 is provided at the side of the other end of the rotating shaft 62, and it measures rotation angle of the elevation adjusting rotating mirror 55 and outputs the measured results to the controlling unit 26.

One of the mirror holding plates 61 is mounted with an elevation adjusting driving motor 65. The elevation adjusting driving motor 65 has an output shaft into which a driving gear 66 is fitted. The driving gear 66 is engaged with the elevation gear 63 that is mounted to the rotating shaft 62. The elevation adjusting driving motor 65 is controlled by the controlling unit 26 and is thereby appropriately driven based on the results that are measured by the elevation sensor 64.

A bead rear sight 67 is provided on the top of the floodlight casing 59. The bead rear sight 67 is used for approximate collimation with respect to the object. The collimation direction using the bead rear sight 67 is the extending direction of the floodlight axis 56 and is a direction which orthogonally crosses the extending direction of the rotating shaft 62.

FIG. 14 is a block diagram of the controlling unit 26. The controlling unit 26 receives detection signals from the horizontal angle sensor 44, the elevation sensor 64, and the tilt sensor 37. The controlling unit 26 also receives instruction signals from a controller 6. The controlling unit 26 drives and controls the horizontal rotation driving motor 38, the elevation adjusting driving motor 65, and the level motor 34, and also controls a display 7 that displays working condition and measurement results, etc. The controlling unit 26 is removably provided with an external storage device 68 such as a memory card, a HDD, or the like.

The controlling unit 26 is formed of a processing unit 4, a memory 5, a horizontally driving unit 69, an elevation driving unit 70, a level driving unit 71, a distance data processing unit 72, an image data processing unit 73, etc. The memory 5 stores various programs, an integrating and controlling program for these programs, and various data such as measured data, image data, and the like. The programs include sequential programs necessary for measuring distances, elevation angles, and horizontal angles, calculation programs, programs for executing processing of measured data, and image processing programs. The programs also include programs for extracting planes from point cloud data and calculating contours, and image display programs for displaying the calculated contours on the display 7. The horizontally driving unit 69 drives and controls the horizontal rotation driving motor 38. The elevation driving unit 70 drives and controls the elevation adjusting driving motor 65. The level driving unit 71 drives and controls the level motor 34. The distance data processing unit 72 processes distance data that are obtained by the distance measuring unit 24. The image data processing unit 73 processes image data that are obtained by the imaging unit 25.

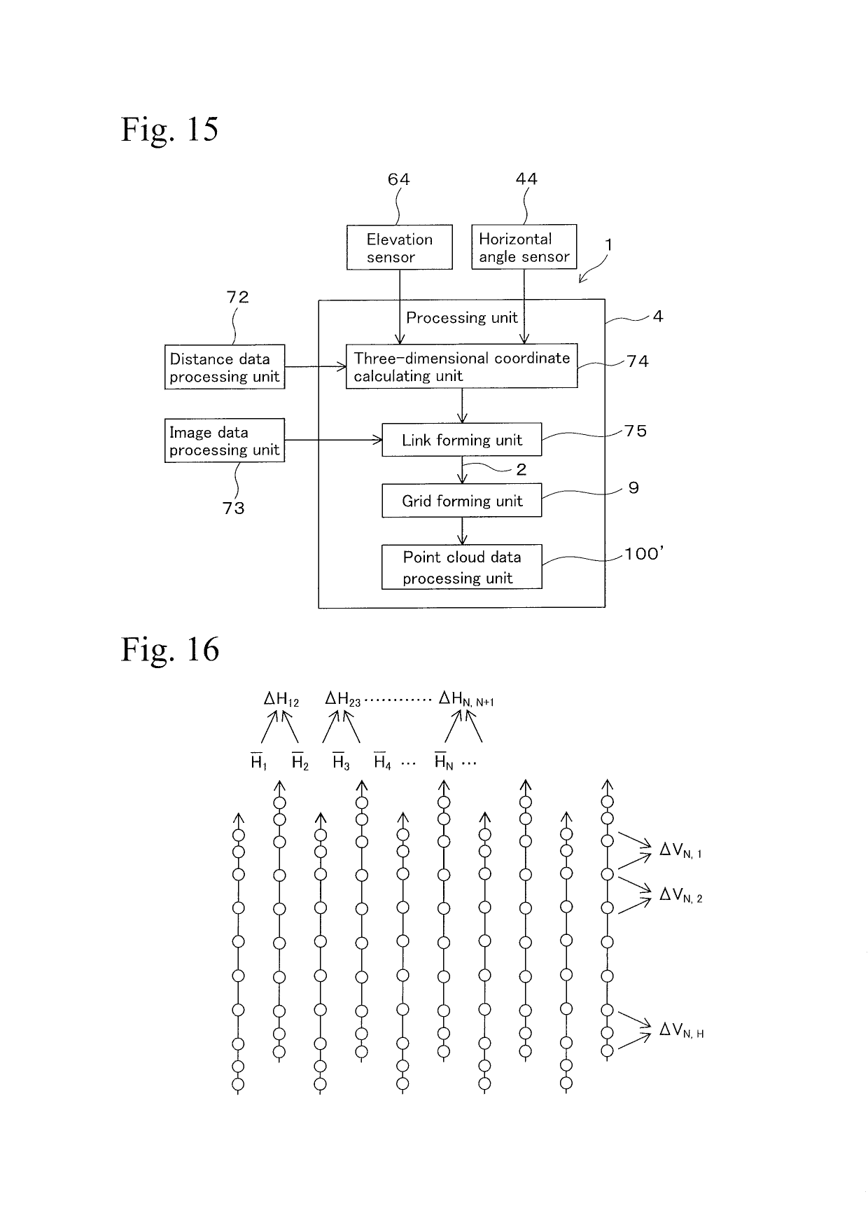

FIG. 15 is a block diagram of the processing unit 4. The processing unit 4 has a three-dimensional coordinate calculating unit 74, a link forming unit 75, a grid forming unit 9, and a point cloud data processing unit 100′. The three-dimensional coordinate calculating unit 74 receives the distance data of the target point from the distance data processing unit 72 and also receives direction data (horizontal angle and elevation angle) of the target point from the horizontal angle sensor 44 and the elevation sensor 64. The three-dimensional coordinate calculating unit 74 calculates three-dimensional coordinates (orthogonal coordinates) of each of the target points having the origin (0, 0, 0) at the position of the point cloud data processing device 1, based on the received distance data and the received direction data.

The link forming unit 75 receives the image data from the image data processing unit 73 and data of three-dimensional coordinates of each of the target points, which are calculated by the three-dimensional coordinate calculating unit 74. The link forming unit 75 forms point cloud data 2 in which image data (RGB intensity of each of the target points) are linked with the three-dimensional coordinates. That is, the link forming unit 75 forms data by linking a position of a target point of the object in a two-dimensional image with three-dimensional coordinates of the target point. The linked data are calculated with respect to all of the target points and thereby form the point cloud data 2.

The point cloud data processing device 1 can acquire point cloud data 2 of the object that are measured from different directions. Therefore, if one measuring direction is represented as one block, the point cloud data 2 consists of two-dimensional images and three-dimensional coordinates of plural blocks.

The link forming unit 75 outputs the point cloud data 2 to the grid forming unit 9. The grid forming unit 9 forms a grid (meshes) with equal distances and registers the nearest points on the intersection points of the grid when distances between adjacent points of the point cloud data 2 are not constant. Alternatively, the grid forming unit 9 corrects all points to the intersection points of the grid by using a linear interpolation method or a bicubic method. When the distances between the points of the point cloud data 2 are constant, the processing of the grid forming unit 9 may be skipped.

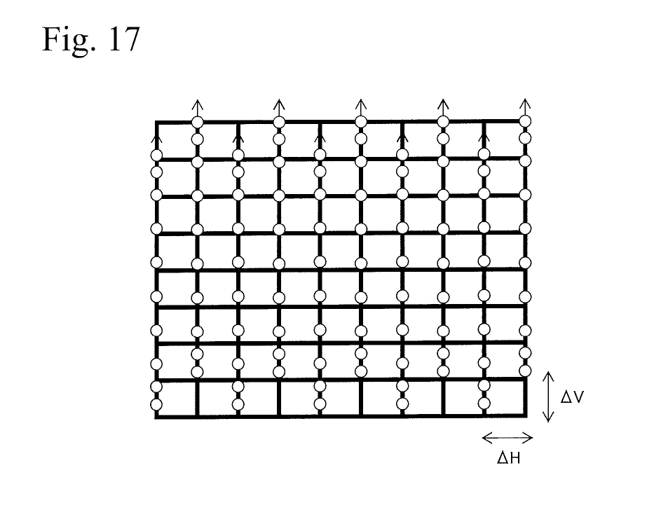

A processing of forming the grid will be described hereinafter. FIG. 16 shows point cloud data in which distances between the points are not constant, and FIG. 17 shows a formed grid. As shown in FIG. 16, an average horizontal distance H_{1˜N} of each line is obtained, and a difference ΔH_{i,j} of the average horizontal distances between the lines is calculated. Then, the difference ΔH_{i,j} is averaged and obtained as a horizontal distance ΔH of the grid (Second Formula). In regard to distances in the vertical direction, a distance ΔV_{N,H} between adjacent points in each line in the vertical direction is calculated. Then, an average of ΔV_{N,H} in the entire image of an image size W, H is obtained as a vertical distance ΔV (Third Formula). As shown in FIG. 17, a grid with the calculated horizontal distance ΔH and the calculated vertical distance ΔV is formed.

(ΣΔH_{i,j})/(N−1)=ΔH Second Formula

(ΣΔV_{N,H})/(W×H)=ΔV Third Formula

Next, the nearest points are registered on the intersection points of the formed grid. In this case, predetermined threshold values are set for distances from each point to the intersection points so as to limit the register of the points. For example, the threshold values may be set to be half of the horizontal distance ΔH and be half of the vertical distance ΔV. As in the case of the linear interpolation method and the bicubic method, all points may be corrected by adding weight according to the distances to the intersection points therefrom. In this case, if interpolation is performed, the points are essentially not measured points.

The point cloud data that are thus obtained are output to the point cloud data processing unit 100′. The point cloud data processing unit 100′ operates the processing that is described in the First Embodiment when the controller 6 in FIG. 14 is controlled by a user. As a result, an obtained image is displayed on the display 7 of the liquid crystal display. This structure is the same as in the case that is described in the First Embodiment.

The point cloud data processing unit 100′ has the same structure as the point cloud data processing device 100 in FIG. 1 except that the image display device 109 and the instruction input device 110 are not included. In this case, the point cloud data processing unit 100′ is a piece of hardware formed of a dedicated integrated circuit using a FPGA. The point cloud data processing unit 100′ processes point cloud data in the same manner as in the point cloud data processing device 100.

### Modification

In the structure of the controlling unit 26, the grid forming unit 9 may be made so as to output the point cloud data. In this case, the grid forming unit 9 functions as a three-dimensional laser scanner, which can be used in combination with the point cloud data processing device 100 in the First Embodiment. On the other hand, by combining a three-dimensional scanner, in which the grid forming unit 9 outputs the point cloud data, and the point cloud data processing device 100 in FIG. 1, a point cloud data processing system using the present invention is obtained. In this case, the point cloud data processing device 100 is made so as to receive the output of the three-dimensional scanner and performs the processing described in the First Embodiment.

### 3. Third Embodiment

A point cloud data processing device equipped with an image measuring unit that has stereo cameras will be described hereinafter. The same components as in the First and the Second Embodiments are indicated by the same reference numerals as in the case of the First and the Second Embodiments, and descriptions thereof are omitted.

### Structure of Point Cloud Data Processing Device

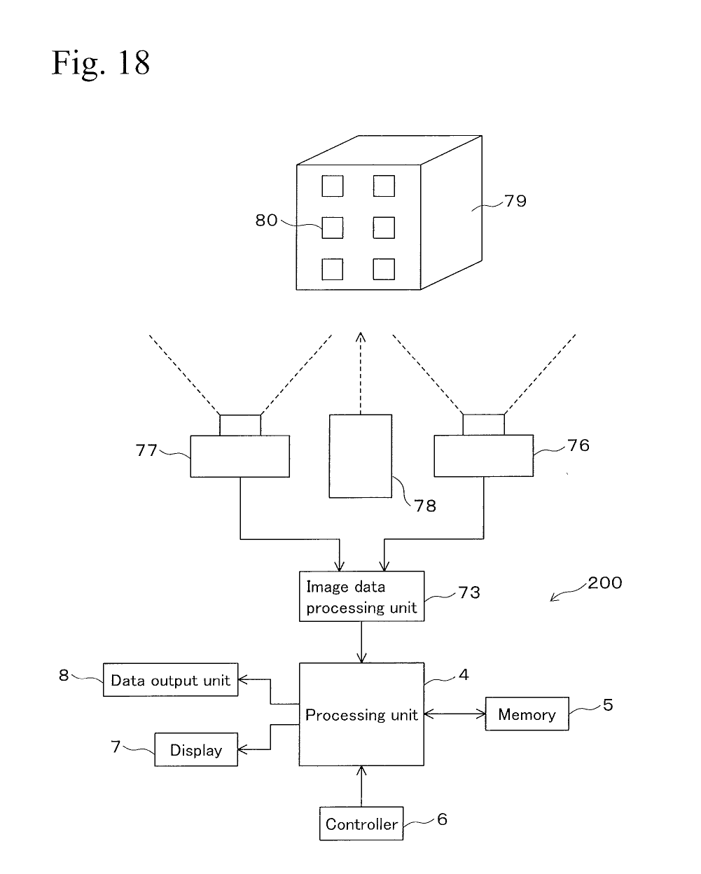

FIG. 18 shows a point cloud data processing device 200. The point cloud data processing device 200 has a combined structure of a point cloud data processing function using the present invention and an image measuring function that is provided with stereo cameras. The point cloud data processing device 200 photographs an object from different directions in overlapped photographing areas and obtains overlapping images, and it matches feature points in the overlapping images. Then, the point cloud data processing device 200 calculates three-dimensional coordinates of the feature points based on positions and directions of photographing units and positions of the feature points in the overlapping images. The positions and the directions of the photographing units are preliminary calculated. Next, the point cloud data processing device 200 forms point cloud data by linking the two-dimensional image and the three-dimensional coordinates based on disparity of the feature points in the overlapping images, the measurement space, and a reference shape. Moreover, the point cloud data processing device 200 performs the plane labeling and calculates data of contours, based on the point cloud data.

FIG. 18 is a block diagram showing a structure of the point cloud data processing device 200. The point cloud data processing device 200 is equipped with photographing units 76 and 77, a feature projector 78, an image data processing unit 73, a processing unit 4, a memory 5, a controller 6, a display 7, and a data output unit 8. The photographing units 76 and 77 are used for obtaining stereo images and may be digital cameras, video cameras, CCD cameras (Charge Coupled Device Cameras) for industrial measurement, CMOS cameras (Complementary Metal Oxide Semiconductor Cameras), or the like. The photographing units 76 and 77 function as stereo cameras that photograph an object from different positions in overlapped photographing areas. The number of the photographing units is not limited to two and may be three or more.

The feature projector 78 may be a projector, a laser unit, or the like. The feature projector 78 projects random dot patterns, patterns of a point-like spotlight or a linear slit light, or the like, to the object. As a result, portions having few features of the object are characterized, whereby image processing is easily performed. The feature projector 78 is used primarily in cases of precise measurement of artificial objects of middle to small size with few patterns. In measurements of relatively large objects normally outdoors, and in cases in which precise measurement is not necessary, or in cases in which the object has features or patterns that can be applied to the object, the feature projector 78 may not be used.

The image data processing unit 73 transforms the overlapping images that are photographed by the photographing units 76 and 77 into image data that are processable by the proceeding unit 4. The memory 5 stores various programs and various data such as point cloud data and image data. The programs include programs for measuring photographing position and direction and programs for extracting feature points from the overlapping images and matching them. The programs also include programs for calculating three-dimensional coordinates based on the photographing position and direction and positions of the feature points in the overlapping images. Moreover, the programs include programs for identifying mismatched points and forming point cloud data, programs for extracting planes from the point cloud data and calculating contours, and programs for displaying images of the calculated contours on the display 7.

The controller 6 is controlled by a user and outputs instruction signals to the processing unit 4. The display 7 displays processed data of the processing unit 4, and the data output unit 8 outputs the processed data of the processing unit 4 to the outside. The processing unit 4 receives the image data from the image data processing unit 73. The processing unit 4 measures the positions and the directions of the photographing units 76 and 77 based on photographed images of a calibration object 79 when two or more fixed cameras are used. In addition, the processing unit 4 extracts feature points from within the overlapping images of the object and matches them. Then, the processing unit 4 calculates the positions and the directions of the photographing units 76 and 77. The processing unit 4 calculates three-dimensional coordinates of the object based on the positions of the feature points in the overlapping images, thereby forming point cloud data 2. Moreover, the processing unit 4 extracts planes from the point cloud data 2 and calculates contours of the object.

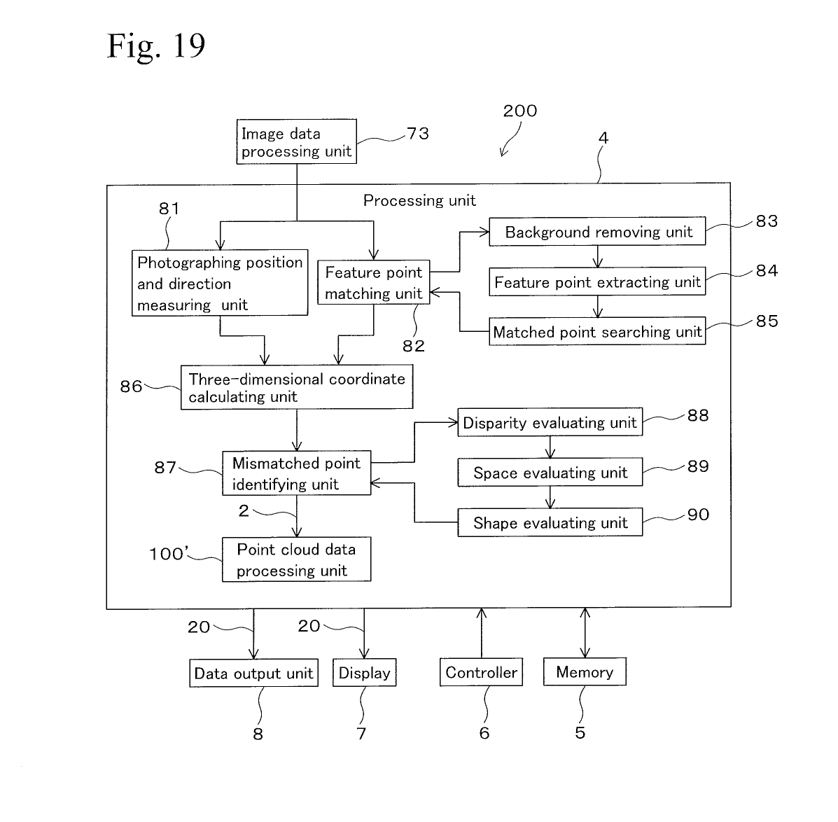

FIG. 19 is a block diagram of the processing unit 4. The processing unit 4 has a point cloud data processing unit 100′, a photographing position and direction measuring unit 81, a feature point matching unit 82, a background removing unit 83, a feature point extracting unit 84, and a matched point searching unit 85. The processing unit 4 also has a three-dimensional coordinate calculating unit 86, a mismatched point identifying unit 87, a disparity evaluating unit 88, a space evaluating unit 89, and a shape evaluating unit 90.

The point cloud data processing unit 100′ has the same structure as the point cloud data processing device 100 in FIG. 1 except that the image display device 109 and the instruction input device 110 are not included. In this case, the point cloud data processing unit 100′ is a piece of hardware formed of a dedicated integrated circuit using a FPGA. The point cloud data processing unit 100′ processes point cloud data in the same manner as in the point cloud data processing device 100.

The photographing position and direction measuring unit 81 receives image data of the overlapping images, which are photographed by the photographing units 76 and 77, from the image data processing unit 73. As shown in FIG. 18, the calibration object 79 is affixed with targets 80 (retro target, code target, or color code target) at predetermined distances. The photographing position and direction measuring unit 81 detects image coordinates of the targets 80 from the photographed images of the calibration object 79 and measures positions and directions of the photographing units 76 and 77 by publicly known methods. The method may be a relative orientation method, a single photo orientation or a DLT (Direct Linear Transformation) method, or a bundle adjusting method. The relative orientation method, the single photo orientation or the DLT method, and the bundle adjusting method, may be used separately or in combination.

The feature point matching unit 82 receives the overlapping images of the object from the image data processing unit 73, and it extracts feature points of the object from the overlapping images and matches them. The feature point matching unit 82 is formed of the background removing unit 83, the feature point extracting unit 84, and the matched point searching unit 85. The background removing unit 26 generates an image with no background, in which only the object is contained. In this case, a background image, in which the object is not contained, is subtracted from the photographed image of the object. Alternatively, target portions are selected by a user with the controller 6, or target portions are automatically extracted by using models that are preliminary registered or by automatically detecting portions with abundant features. If it is not necessary to remove the background, the processing of the background removing unit 26 may be skipped.

The feature point extracting unit 84 extracts feature points from the image with no background. In order to extract the feature points, a differentiation filter such as a Sobel, Laplacian, Prewitt, and Roberts, is used. The matched point searching unit 85 searches matched points, which correspond to the feature points extracted from one image, in the other image. In order to search the matched points, a template matching method such as a sequential similarity detection algorithm method (SSDA), a normalized correlation method, and an orientation code matching (OCM), is used.

The three-dimensional coordinate calculating unit 86 calculates three-dimensional coordinates of each of the feature points based on the positions and the directions of the photographing units 76 and 77 that are measured by the photographing position and direction measuring unit 81. This calculation is performed also based on image coordinates of the feature points that are matched by the feature point matching unit 82. The mismatched point identifying unit 87 identifies mismatched points based on at least one of disparity, the measurement space, and a reference shape. The mismatched point identifying unit 87 is formed of the disparity evaluating unit 88, the space evaluating unit 89, and the shape evaluating unit 90.

The disparity evaluating unit 88 forms a histogram of disparity of the feature points matched in the overlapping images. Then, the disparity evaluating unit 88 identifies feature points, of which the disparity is outside a predetermined range from an average value of the disparity, as mismatched points. For example, an average value ±1.5σ (standard deviation) may be set as a threshold value. The space evaluating unit 89 defines a space within a predetermined distance from the center of gravity of the calibration object 70, as a measurement space. In addition, the space evaluating unit 89 identifies feature points as mismatched points when three-dimensional coordinates of the feature points calculated by the three-dimensional coordinate calculating unit 86 are outside the measurement space. The shape evaluating unit 90 forms or retrieves a reference shape (rough planes) of the object from the three-dimensional coordinates of the feature points, which are calculated by the three-dimensional coordinate calculating unit 86. In addition, the shape evaluating unit 90 identifies mismatched points based on distances between the reference shape and the three-dimensional coordinates of the feature points. For example, TINs (Triangulated Irregular Networks) with a side of not less than a predetermined length are formed based on the feature points. Then, TINs with a long side are removed, whereby rough planes are formed. Next, mismatched points are identified based at distances between the rough planes and the feature points.

The mismatched point identifying unit 87 forms point cloud data 2 by removing the mismatched points that are identified. The point cloud data 2 has a directly linked structure in which the two-dimensional images are linked with the three-dimensional coordinates. When distances between adjacent points of the point cloud data 2 are not constant, as described in the Second Embodiment, the processing unit 4 must have the grid forming unit 9 between the mismatched point identifying unit 87 and the point cloud data processing unit 100′. In this case, the grid forming unit 9 forms a grid (meshes) with equal distances and registers the nearest points on the intersection points of the grid. Then, as described in the First Embodiment, planes are extracted from the point cloud data 2, and contours of the object are calculated.

According to the Third Embodiment, point cloud data consisting of two-dimensional images and three-dimensional coordinates are obtained by the image measuring unit. The image measuring unit may be made so as to output the point cloud data from the mismatched point identifying unit 87. In addition, the point cloud data processing device 100 in FIG. 1 may be made so as to receive the output of this image measuring unit and perform processing described in the First Embodiment. In this case, by combining the image measuring unit and the point cloud data processing device 100, a point cloud data processing system using the present invention is obtained.

The present invention can be used in techniques of measuring three-dimensional information.

What is claimed is:

1. A point cloud data processing device for processing point cloud data including points of non-plane areas and plane areas of an object, the device comprising:
a non-plane area removing unit for removing the points of the non-plane areas based on the point cloud data of the object;
a plane labeling unit for adding identical labels to points in the same planes other than the points removed by the non-plane area removing unit so as to segment the point cloud data into planes; and
a contour calculating unit for calculating a contour at a portion between a first plane and a second plane, which have the non-plane area therebetween and which have a different label, the contour differentiating the first plane and the second plane,
wherein the contour calculating unit includes a local area obtaining unit and a local plane obtaining unit, the local area obtaining unit obtains a local area, which connects with the first plane and is based on the point cloud data of the non-plane area, between the first plane and the second plane, the local plane obtaining unit obtains a local plane that fits to the local area and that differs from the first plane and the second plane in direction, and the contour calculating unit calculates the contour based on the local plane by setting the local area as a square area that is formed of N×N points in which N is a natural number of not less than three.

2. The point cloud data processing device according to claim 1, wherein the contour calculating unit includes a local area obtaining unit and a local plane obtaining unit, the local area obtaining unit obtains a first local area and a second local area between the first plane and the second plane, the first local area connects with the first plane and is based on the point cloud data of the non-plane area, the second local area connects with the second plane and is based on the point cloud data of the non-plane area, the local plane obtaining unit obtains a first local plane and a second local plane, the first local plane fits to the first local area and differs from the first plane and the second plane in direction, the second local plane fits to the second local area and differs from the first plane and the second plane in direction, and the contour calculating unit calculates the contour based on the first local plane and the second local plane by setting each of the first local area and the second local area as a square area that is formed of N×N points in which N is a natural number of not less than three.

3. The point cloud data processing device according to claim 2, wherein the first local plane and the second local plane form a connecting plane that connects the first plane and the second plane.

4. The point cloud data processing device according to claim 2, wherein one or plural local planes are obtained between the first plane and the first local plane and between the second plane and the second local plane.

5. The point cloud data processing device according to claim 2, wherein the contour is calculated as a line of intersection of the first local plane and the second local plane.

6. The point cloud data processing device according to claim 1, wherein a threshold value for evaluating the non-plane area, and a threshold value for evaluating the same planes are used, removing of the points of the non-plane area is performed again by changing the threshold value for evaluating the non-plane area, and adding of the identical labels to the points in the same planes is performed again by changing the threshold value for evaluating the same planes.

7. The point cloud data processing device according to claim 1, further comprising a smoothing unit for smoothing the contour.

8. The point cloud data processing device according to claim 1, further comprising a three-dimensional contour image display controlling unit that controls displaying of a three-dimensional image of the contour of the object on an image display device based on result of the calculation performed by the contour calculating unit.

9. The point cloud data processing device according to claim 1, further comprising:
a display controlling unit for displaying the planes, which are obtained by segmenting the point cloud data by the plane labeling unit, on the image display device;
a plane selecting unit that enables selection of two adjacent planes from the planes that are displayed on the image display device; and
a selected plane identifying unit for identifying the two adjacent planes as the first plane and the second plane, respectively.

10. The point cloud data processing device according to claim 9, wherein the planes are displayed in different display styles.

11. The point cloud data processing device according to claim 9, wherein the selected two planes are highlighted.

12. The point cloud data processing device according to claim 1, further comprising:
an unnecessary plane selecting unit for selecting a plane, which need not be calculated for obtaining a contour, from the planes that are obtained by segmenting the point cloud data by the plane labeling unit; and
a data storage unit for storing data for selecting the plane that need not be calculated for obtaining a contour; or
an input receiving unit for receiving input instruction for selecting the plane that need not be calculated for obtaining a contour.

13. The point cloud data processing device according to claim 12, further comprising a hidden contour calculating unit for calculating a contour that is hidden behind the plane that need not be calculated for obtaining a contour.

14. The point cloud data processing device according to claim 1, further comprising:
a rotationally emitting unit for rotationally emitting distance measuring light on an object;
a distance measuring unit for measuring a distance from the point cloud data processing device to a target point on the object based on flight time of the distance measuring light;
an emitting direction measuring unit for measuring emitting direction of the distance measuring light;
a three-dimensional coordinate calculating unit for calculating three-dimensional coordinates of the target point based on the distance and the emitting direction; and
a point cloud data obtaining unit for obtaining point cloud data of the object based on result of the calculation performed by the three-dimensional coordinate calculating unit, the point cloud data including points of non-plane areas and plane areas of the object,
wherein the non-plane area removing unit removes the points of the non-plane areas based on the point cloud data of the object.

15. The point cloud data processing device according to claim 1, further comprising:
a photographing unit for taking images of an object in overlapped photographing areas from different directions;
a feature point matching unit for matching feature points in overlapping images obtained by the photographing unit;
a photographing position and direction measuring unit for measuring the position and the direction of the photographing unit;
a three-dimensional coordinate calculating unit for calculating three-dimensional coordinates of the feature points based on the position and the direction of the photographing unit and the positions of the feature points in the overlapping images; and
a point cloud data obtaining unit for obtaining point cloud data of the object based on result of the calculation performed by the three-dimensional coordinate calculating unit, the point cloud data including points of non-plane areas and plane areas of the object,
wherein the non-plane area removing unit removes the points of the non-plane areas based on the point cloud data of the object.

16. A point cloud data processing method for processing point cloud data including points of non-plane areas and plane areas of an object, the method comprising:
a non-plane area removing step for removing the points of the non-plane areas based on the point cloud data of the object;
a plane labeling step for adding identical labels to points in the same planes other than the points removed by the non-plane area removing step so as to segment the point cloud data into planes; and
a contour calculating step for calculating a contour at a portion between a first plane and a second plane, which have the non-plane area therebetween and which have a different label, the contour differentiating the first plane and the second plane,
wherein the contour calculating step includes a local area obtaining step and a local plane obtaining step, the local area obtaining step performs obtaining of a local area, which connects with the first plane and is based on the point cloud data of the non-plane area, between the first plane and the second plane, the local plane obtaining step performs obtaining of a local plane, which fits to the local area and differs from the first plane and the second plane in direction, and the contour calculating step performs calculating of the contour based on the local plane by setting the local area as a square area that is formed of N×N points in which N is a natural number of not less than three.

17. A point cloud data processing program for processing point cloud data including points of non-plane areas and plane areas of an object, which is read and is executed by a computer so that the computer functions as the following means comprising:
a non-plane area removing means for removing the points of the non-plane areas based on the point cloud data of the object;
a plane labeling means for adding identical labels to points in the same planes other than the points removed by the non-plane area removing means so as to segment the point cloud data into planes; and
a contour calculating means for calculating a contour at a portion between a first plane and a second plane, which have the non-plane area therebetween and which have a different label, the contour differentiating the first plane and the second plane,
wherein the contour calculating means includes a local area obtaining means and a local plane obtaining means, the local area obtaining means obtains a local area, which connects with the first plane and is based on the point cloud data of the non-plane area, between the first plane and the second plane, the local plane obtaining means obtains a local plane that fits to the local area and that differs from the first plane and the second plane in direction, and the contour calculating means calculates the contour based on the local plane by setting the local area as a square area that is formed of N×N points in which N is a natural number of not less than three.
